(19) United States
(12) Patent Application Publication
(10) Pub. No.: US 2024/0295062 A1
(43) Pub. Date: Sep. 5, 2024

(54) LAUNDRY TREATING APPARATUS

(71) Applicant: LG Electronics Inc., Seoul (KR)

(72) Inventors: Jungchul KIM, Seoul (KR); Sangin CHUNG, Seoul (KR); Eunsoo JUNG, Seoul (KR)

(21) Appl. No.: 18/575,032

(22) PCT Filed: Jun. 14, 2022
(86) PCT No.: PCT/KR2022/008359

§ 371 Date: Dec. 28, 2023

(30) Foreign Application Priority Data
Jun. 28, 2021 (KR) 10-2021-0084024

(51) Int. Cl. D06F 34/30; D06F 34/32; D06F 39/12; D06F 58/20; D06F 101/20; D06F 105/58; G05G 1/01

(52) U.S. Cl. CPC D06F 34/30; D06F 34/32; D06F 39/12; D06F 58/20; G05G 1/01; D06F 2101/20; D06F 2105/58

(57) ABSTRACT

A laundry treating apparatus is disclosed. The laundry treating apparatus according to one embodiment of the present invention comprises: a cabinet; a drum; a screen output unit; a movement button unit; and a multifunctional button unit, wherein the movement button unit is provided at the cabinet, and is operated by a user to change a to-be-selected object that is to be selected from among a plurality of objects, and the multi-functional button unit is provided at the screen output unit and has functions that vary according to screens output from the screen output unit.

### TECHNICAL FIELD

The present disclosure relates to a laundry treatment apparatus and, more particularly, to a laundry treatment apparatus including a screen output part configured to output a screen and a manipulation part manipulated by a user.

### BACKGROUND ART

Electronic devices including a laundry treatment apparatus that washes clothes (herein, clothes refer to objects to be washed or objects to be dried), dries clothes, or both washes and dries clothes are indispensably equipped with an input/output device (interface) that allows a user to input control commands to the electronic devices.

Among conventional interfaces, there is an interface designed such that a display on which control commands selectable by the user are displayed, a search part that allows the user to search for control commands displayed on the display, a multi-function button part that allows the user to select control commands displayed on the display part, and an input part that requests execution of control commands selected by the user are positioned in separate spaces (Korean Publication No. 10-2014-0023986).

That is, in a conventional interface, a display (an LCD, an LED panel, etc.) on which control commands are displayed, a knob or a button for searching for control commands by causing control commands executable by a corresponding electronic device to be displayed on the display, a control command input button for selecting control commands displayed on the display, and a control command input button for requesting execution of the selected control commands are located in separated spaces, respectively, and such arrangement has been a factor that determines design of the interface (design of a control panel) located on the front surface of an electronic device such as a laundry treatment apparatus.

In arrangement of the conventional interface having the above-described structure, since various elements including a display are distributed in a width direction of an electronic device or distributed in a height direction of the electronic device, a lot of space has been required to install the interface.

Accordingly, it is important to improve spatial utilization while improving convenience of use by efficiently arranging the screen output part, the manipulation part, the option part, and the like, constituting the interface.

The related document KR 10-2016-0062917 A discloses a laundry treatment apparatus including a screen output part. The laundry treatment apparatus includes a rotatable knob around the screen output part.

A user may select various selection items displayed in the screen output part of the laundry treatment apparatus by rotating the knob, and a plurality of buttons, such as a start button of a course for treating laundry or a power button, is additionally provided in the screen output part.

Since a plurality of buttons is provided in the screen output part of the laundry treatment apparatus, a screen area provided in an inner space defined by the knob may be reduced, and the intuitiveness of each button by the user may be degraded.

Furthermore, a display of the screen output part, which has a limited area due to the knob and the plurality of buttons, may be disadvantageous in displaying various information due to a limited output area.

Therefore, it is important in this technical field to effectively increase a screen area of the screen output part by efficiently configuring various buttons constituting a manipulation part and to effectively provide various information to the user in a limited screen area.

### DISCLOSURE

### Technical Problem

Embodiments of the present disclosure are intended to provide a laundry treatment apparatus that includes a screen output part capable of effectively providing various information to a user during a laundry treatment process and includes a manipulation part that allows a user to conveniently input a manipulation signal.

In addition, embodiments of the present disclosure are intended to provide a laundry treatment apparatus in which an installation area of a screen output part for outputting a screen and a manipulation part for generating a manipulation signal is effectively set in a limited area.

In addition, embodiments of the present disclosure are intended to provide a laundry treatment apparatus that includes a manipulation part capable of efficiently generating various manipulation signals manipulated by a user in order for the laundry treatment apparatus to perform a laundry treatment process and effectively reducing an installation space.

In addition, embodiments of the present disclosure are intended to provide a laundry treatment apparatus that effectively displays various information in a limited screen area to effectively improve convenience of use and improve utilization of space.

### Technical Solution

According to an embodiment of the present disclosure, a movement button part may be provided. The movement button part may be provided in the form of angle brackets on the left and right of a screen output part. That is, the movement button part may have a shape indicating that a function of a corresponding button is related to movement.

According to an embodiment of the present disclosure, since a multi-function button part may be variously used for each screen, the number of buttons may be effectively reduced and convenience of manipulation by a user may be improved.

A laundry treatment apparatus according to an embodiment of the present disclosure includes a cabinet, a drum, a screen output part, a movement button part, and a multi-function button part. The drum is rotatably provided inside the cabinet and accommodates clothes therein

The screen output part is provided in the cabinet and is configured to output a screen on which a plurality of objects selectable by a user is displayed. The movement button part may be provided in the cabinet and be manipulated by the user to move a selection target object displayed on any one of the plurality of objects.

The multi-function button part may be provided in the screen output part and be configured to vary a function according to a screen output from the screen output part. The movement button part may include a first movement button part and a second movement button part.

The first movement button part may move the selection target object on the screen output from the screen output part in one direction, and the second movement button part may move the selection target object on the screen output from the screen output part in the other direction.

Based on a width direction of the cabinet, the first movement button part may be located on one side of the screen output part, and the second movement button part may be located on the other side of the screen output part.

The movement button part may be displayed in a form of lines bent towards opposite directions on the cabinet. The screen output part may include a border line extending along a border of the screen output part, and the movement button part may be located outside the border line.

The border line, the movement button part, and a circumference of the multi-function button part may be configured to emit light. The multi-function button part may be configured to emit light in a state in which the function is activated.

The screen output part may include a display on which the screen is output, and a screen circumference part surrounding and fixing the display. The multi-function button part may be provided in the screen circumference part.

The screen output part may be provided on the front surface of the cabinet, and the multi-function button part may be disposed below the display in the screen circumference part 849.

The display may be provided in a rectangular shape. The screen circumference part may be provided in a circular shape, and the display may be fixed to an inside of the screen circumference part. The screen output part may include a function display area for displaying a current function of the multi-function button part.

A general option part may be positioned on one side of the screen output part based on a width direction of the cabinet and be manipulated by the user to adjust an option of a course for treating laundry.

The general option part may include a first option adjuster configured to adjust a first option of the course, and a second option adjuster configured to adjust a second option of the course. The first option adjuster and the second option adjuster may be aligned in the width direction.

The general option part may include an option display part in which an option setting value of the option is displayed, and an option button part through which the option setting value of the option is adjusted.

The option display part may include a plurality of light emitting parts aligned in parallel in one direction. The plurality of light emitting parts may be related to a plurality of option values for the option, respectively. The option display part may provide information about the option setting value to the user by causing a light emitting part related to the option setting value among the plurality of option values to emit light among the plurality of light emitting parts.

The laundry treatment apparatus may further include a controller configured to control rotation of the drum and to perform the course. A plurality of courses may be stored in the controller, and an option group settable by the user with respect to each of the plurality of courses may be preset. The option display part and the option button part may be configured to emit light together. The option display part and the option button part may emit light together based on the option group for a course currently displayed in the screen output part.

The laundry treatment apparatus may further include an additional option part positioned on the other side of the screen output part based on the width direction and be manipulated by the user to adjust an additional option other than the option related to the general option part.

The screen output part and the movement button part may be disposed between the general option part and the additional option part based on the width direction. The additional option part may include a plurality of additional option button parts through which different additional options are adjusted. The plurality of additional option button parts may be arranged in a grid form.

The additional option part may include a plurality of additional option button parts through which different additional options are adjusted. Each of the plurality of additional option button parts may be configured to display a name of a related additional option and to emit light. The plurality of additional option button parts may emit light based on an additional option settable in the course displayed in the screen output part.

The laundry treatment apparatus may further include a power button part and an execution button part provided in the cabinet. The screen output part, the movement button part, the general option part, and the additional option part may all disposed between the power button part and the execution button part based on the width direction. The movement button part, the power button part, and the execution button part may be arranged in parallel in the width direction.

In the laundry treatment apparatus according to an embodiment of the present disclosure, the multi-function button part may be provided inside the screen output part, and the movement button part may be provided outside the screen output part.

### Advantageous Effects

Embodiments of the present disclosure provide a laundry treatment apparatus that includes a screen output part capable of effectively providing various information to the user during a laundry treatment process and includes a manipulation part that allows a user to conveniently input a manipulation signal.

In addition, embodiments of the present disclosure provide a laundry treatment apparatus in which an installation area of a screen output part for outputting a screen and a manipulation part for generating a manipulation signal is effectively set in a limited area.

In addition, embodiments of the present disclosure provide a laundry treatment apparatus that includes a manipulation part capable of efficiently generating various manipulation signals manipulated by a user in order for laundry treatment apparatus to perform a laundry treatment process and effectively reducing an installation space.

In addition, embodiments of the present disclosure provide a laundry treatment apparatus that effectively displays various information in a limited screen area to effectively improve convenience of use and improve utilization of space.

### BRIEF DESCRIPTION OF DRAWINGS

FIG. 1 is a diagram illustrating a front-loading laundry treatment apparatus according to an embodiment of the present disclosure.

FIG. 2 is a diagram illustrating a top-loading laundry treatment apparatus according to an embodiment of the present disclosure.

FIG. 3 is a diagram illustrating an internal cross-section of a laundry treatment apparatus according to an embodiment of the present disclosure.

FIG. 4 is a diagram illustrating a control panel in the laundry treatment apparatus according to an embodiment of the present disclosure.

FIG. 5 is a diagram illustrating a screen output part in the laundry treatment apparatus according to an embodiment of the present disclosure.

FIG. 6 is a diagram illustrating a general option part in the laundry treatment apparatus according to an embodiment of the present disclosure.

FIG. 7 is a diagram illustrating an additional option part in the laundry treatment apparatus according to an embodiment of the present disclosure.

FIG. 8 is a diagram schematically illustrating screens output from a screen output part according to each progress stage in the laundry treatment apparatus according to an embodiment of the present disclosure.

FIG. 9 is a diagram illustrating a notification screen out of a booting screen output from a screen output part during a booting process according to an embodiment of the present disclosure.

FIG. 10 is a diagram illustrating a course selection screen out of a course setting screen 400 output from a screen output part during a course setting process according to an embodiment of the present disclosure.

FIG. 11 is a diagram illustrating a course progress screen out of a laundry treatment screen output from a screen output part during a laundry treatment process according to an embodiment of the present disclosure.

FIG. 12 is a diagram illustrating an option screen output from a screen output part according to an embodiment of the present disclosure.

FIG. 13 is a diagram illustrating an option recommendation screen output from a screen output part according to an embodiment of the present disclosure.

FIG. 14 is a diagram illustrating a setting screen output from a screen output part according to an embodiment of the present disclosure.

### BEST MODE

Hereinbelow, embodiments of the present disclosure will be described in detail with reference to the accompanying drawings so that the present disclosure may be easily implemented by those skilled in the art.

However, the present disclosure may be achieved in various different forms and is not limited to the embodiments described herein. In the drawings, parts that are not related to a description of the present disclosure are omitted to clearly explain the present disclosure and similar reference numbers will be used throughout this specification to refer to similar parts.

In this specification, a redundant description of the same component is omitted.

In this specification, it should be understood that, when an element is referred to as being “connected to” or “coupled to” another element, the element may be directly connected to or coupled to the other element or intervening elements may also be present. In contrast, it should be understood that, when an element is referred to as being “directly connected to” or “directly coupled to” another element, no intervening elements are present.

The terms used in this specification are used to merely describe specific embodiments and are not intended to limit the present disclosure.

In this specification, a singular representation may include a plural representation unless it represents a definitely different meaning from the context.

In this specification, terms such as “include” or “has” are intended to indicate the presence of features, numbers, steps, operations, elements, components, or combinations thereof used herein and it should be thus understood that the possibility of presence or addition of one or more different features, numbers, steps, operations, elements, components, or combinations thereof is not excluded.

In this specification, the term “and/or” includes any and all combinations of one or more of the associated listed items. In this specification, “A or B” may include “A”, “B”, or “both A and B”.

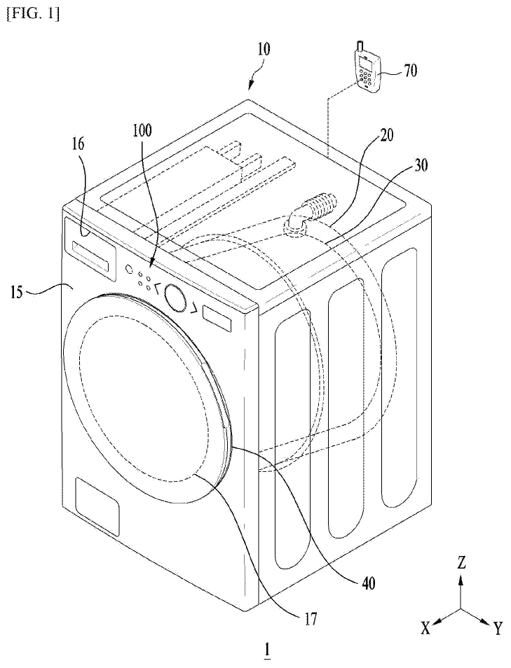

FIG. 1 illustrates the appearance of a laundry treatment apparatus 1 according to an embodiment of the present disclosure. As illustrated in FIG. 1, the laundry treatment apparatus 1 according to an embodiment of the present disclosure may include a cabinet 10.

The cabinet 10 forms the exterior of the laundry treatment apparatus 1 and may have a space therein in which a drum 30 and a tub 20 are provided. Although a hexahedral cabinet 10 is illustrated in FIG. 1, a specific shape of the cabinet 10 may vary.

The cabinet 10 may include a plurality of panels. The plurality of panels may include a front panel 15, a side panel, an upper panel, a lower panel, and a rear panel. The plurality of panels may be coupled to each other to form the cabinet 10.

A detergent opening 16 and a clothing opening 17 may be formed in the front panel 15. The detergent opening 16 may correspond to a passage through which a storage part of a detergent supply device moves, and the clothing opening 17 may correspond to a passage through which the user puts clothes into the drum 30 inside the cabinet 10.

That is, in an embodiment of the present disclosure, the cabinet 10 includes the front panel 15 in which the detergent opening 16 is formed.

The front panel 15 may be provided with a clothing door 40 for opening and closing the clothing opening 17, and the clothing door 40 may be rotatably hinged on the outside of the front panel 15. The clothing opening 17 of the front panel 15 may be opened or closed by the clothing door 40.

Meanwhile, the tub 20 may be provided inside the cabinet 10 and may accommodate water therein. The drum 30 may be rotatably provided in the tub 20 and may accommodate clothes therein.

In an embodiment of the present disclosure, the drum 30 may include a plurality of communication holes on the outer circumferential surface, through which the tub 20 and the inside of the drum 30 communicate with each other, and thus water stored in the tub 20 is supplied to the inside of the drum 30 and supplied to the clothes.

Meanwhile, as illustrated in FIG. 1, the laundry treatment apparatus according to an embodiment of the present disclosure may include both the drum 30 and the tub 20 or may include only the drum 30 without the tub 20 as needed. That is, the laundry treatment apparatus 1 according to an embodiment of the present disclosure corresponds to a washing machine capable of performing a wash course for treating laundry by including the tub 20 in which water is accommodated and the drum 30 or corresponds to a dryer capable of performing a dry course to dry clothes inside the drum 30 by including only the drum 30 without the tub 20.

However, the laundry treatment apparatus 1 according to an embodiment of the present disclosure may include both the drum 30 and the tub 20 and include an air supply part for drying clothes, thereby performing both the wash course and the dry course. Hereinafter, unless otherwise specified, the description will be given based on the form in which the drum 30 and the tub 20 are provided together inside the cabinet 10 in an embodiment of the present disclosure.

Meanwhile, the laundry treatment apparatus 1 according to an embodiment of the present disclosure may include a detergent supply device for performing a wash course. The detergent supply device is provided inside the cabinet 10 or outside the cabinet 10 to supply detergents into the tub 20 or the drum 30.

In the present disclosure, the detergents include not only washing agents for removing foreign substances from clothes, but also softeners for improving the flexibility of fibers and bleaching agents for improving the color of fibers. In addition, the detergents may be defined to include various forms and types of detergents, such as detergents in powdered form as well as detergents in liquid form.

The detergent supply device may include a storage part in which the detergents are stored, and the storage part may be inserted into or withdrawn from the cabinet 10 through the detergent opening 16 of the front panel 15.

Meanwhile, the laundry treatment apparatus 1 according to an embodiment of the present disclosure may include a control panel 100 including a screen output part 8 for outputting a screen and a manipulation part manipulated by the user to generate a manipulation signal.

FIG. 1 illustrates a state in which the control panel 100 is provided on the front panel 15 according to an embodiment of the present disclosure. However, the control panel 100 may be provided not only on the front panel 15, but also on a top or side panel and may be provided on a plurality of panels.

Referring to FIG. 1, in an embodiment of the present disclosure, the control panel 100 may be provided at an upper end part of the front panel 15. The upper end part of the front panel 15 may be understood as a part including the control panel and the upper end of the front panel 15.

The control panel 100 may be manufactured separately from the front panel 15 and coupled to the front panel 15, or a part of the front panel 15 may correspond to the control panel 100. When the control panel 100 is manufactured separately from the front panel 15, the control panel 100 may be provided on the front panel 15 to form the front surface of the cabinet 10 together with the front panel 15.

The control panel 100 may include a manipulation part, and the manipulation part may include buttons operated by the user. The manipulation part may be operated by the user to generate a manipulation signal, and the manipulation signal may be transmitted to a controller 60 which will be described later.

In the present disclosure, the manipulation part refers to an object that the user manipulates to generate a manipulation signal and may include a movement button part 260, a multi-function button part 91, an option button part, and an additional option button part, which will be described later. A detailed description of the manipulation part will be given later.

Meanwhile, the control panel 100 may include the screen output part 8, and the screen output part 8 may include a display 84 for outputting a screen to provide information to the user. A detailed description of the screen output part 8 will be given later in conjunction with the manipulation part.

Meanwhile, an embodiment of the present disclosure may include the controller 60, and the controller 60 may be electrically and signally connected to the manipulation part. In addition, the controller 60 may be electrically and signally connected to objects that require electrical/electronic control, such as a driving part for rotating the drum 30 or a water supply part for supplying water.

The controller 60 may receive a signal input to the manipulation part by the user and control each component of the laundry treatment apparatus 1 based on the received signal. In addition, the controller 60 may transmit an operation situation of the laundry treatment apparatus 1 to the user through the manipulation part based on the signal received from each component.

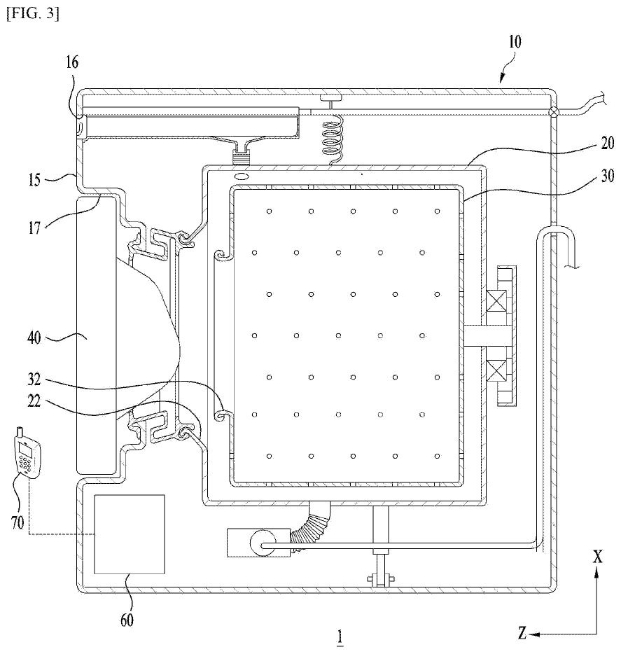

FIG. 3 is a diagram illustrating an internal cross-section of the laundry treatment apparatus 1 according to an embodiment of the present disclosure. The inside of the laundry treatment apparatus 1 according to an embodiment of the present disclosure will be schematically described with reference to FIG. 3 as follows.

The clothing opening 17 of the front panel 15 may be closed by the clothing door 40. When the user wishes to wash clothes, the user may open the clothing opening 17 by manipulating the clothing door 40.

Clothes may be introduced into the opened clothing opening 17, and the clothes introduced through the clothing opening 17 may be transferred to the inside of the drum 30 through a tub opening 22 of the tub 20 and a drum opening 32 of the drum 30.

The tub 20 may be fixed inside the cabinet 10, and a front surface thereof facing the clothing opening 17 may be opened to form the tub opening 22. The tub 20 may be connected to the front panel 15 through a gasket for preventing the separation of the clothes and water leakage. In addition, the tub 20 may be supported on the cabinet 10 through a damper for minimizing vibration transmitted to the cabinet 10.

The drum 30 may be disposed inside the tub 20, and a front surface of the drum 30 facing the tub opening 22 and the clothing opening 17 may be opened to form the drum opening 32. That is, the clothing opening 17, the tub opening 22, and the drum opening 32 may be aligned in parallel to communicate with each other.

As described above, the drum 30 may have a plurality of communication holes formed on the outer circumferential surface thereof so that water accommodated in the tub 20 may be provided into the drum 30. In addition, the drum 30 may include a rotation shaft and may be provided to be rotatable.

The drum 30 may be connected to the driving part through the rotation shaft. The driving part may provide rotational force based on a signal of the controller 60, and the rotational force of the driving part may be transmitted to the drum 30 through the rotational shaft to rotate the drum 30.

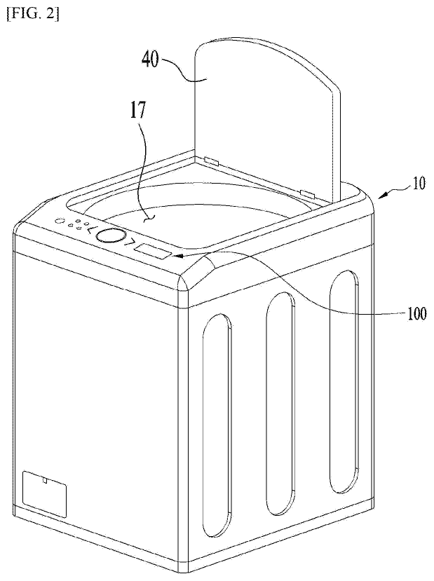

Meanwhile, FIG. 1 illustrates a front-loading laundry treatment apparatus according to an embodiment of the present disclosure, and FIG. 2 illustrates a top-loading laundry treatment apparatus according to an embodiment of the present disclosure.

The front-loading laundry treatment apparatus may be provided in a form in which the drum opening 32, the tub opening 22, and the clothing opening 17 are opened facing forward, so that the rotation shaft of the drum 30 may extend approximately in a front-rear direction. The top-loading laundry treatment apparatus may be provided in a form in which the drum opening 32, the tub opening 22., and the clothing opening 17 are opened upward, so that the rotation shaft of the drum 30 may extend approximately in a vertical direction.

In an embodiment of the present disclosure, the clothing opening 17 and the control panel 100 may be provided on the front surface, i.e., the front panel 15, of the cabinet 10 as illustrated in FIG. 1 or may be provided on the upper surface of the cabinet 10 as illustrated in FIG. 2.

When the clothing opening 17 and the control panel 100 are provided on the front surface of the cabinet 10, the control panel 100 may be located above the clothing opening 17. For example, the control panel 100 may be located at an upper end part of the front surface of the cabinet 10. In an embodiment of the present disclosure, the multi-function button part 91, which will be described later, may be disposed below the display 84 in the screen output part 8 of the control panel 100.

When the clothing opening 17 and the control panel 100 are provided on the upper surface of the cabinet 10, the control panel 100 may be located in front of the clothing opening 17. For example, the control panel 100 may be located at a front end part of the upper surface of the cabinet 10. The multi-function button part 91 may be positioned in front of the display 84 in the screen output part 8 of the control panel 100.

The control panel 100 may include the manipulation part manipulated by the user, and the manipulation part may include a change part for changing, by the user, an object output from the screen output part 8. For example, the changing part may be a dial part rotated by the user or the movement button part 260 pressed or touched by the user.

The abovementioned dial part may have a shape that protrudes from the control panel 100 to have a rotatable structure. When the control panel 100 including such a dial part is applied to the top-loading laundry treatment apparatus illustrated in FIG. 2, in the process of the user putting clothes into the clothing opening 17, the clothes may be caught on the dial part, thereby reducing the convenience of insertion of clothes.

However, according to an embodiment of the present disclosure, the control panel 100 is operated in a manner of being pressed or touched by the user as described below instead of using the dial part and has the movement button part 260 that does not protrude from the cabinet 10. Further, a part protruding from the upper surface of the cabinet 10 in the overall structure of the control panel 100 together with the movement button part 260 is removed or minimized. Therefore, even if the control panel 100 is applied to the top-loading laundry treatment apparatus, it is possible to minimize clothing jams and improve usability.

Meanwhile, the laundry treatment apparatus 1 according to an embodiment of the present disclosure may be connected to an external water supply source to receive water. A water supply part connected to the external water supply source may be provided in the cabinet 10.

The water supply part may include a water supply valve, and the controller 60 may supply water into the tub 20 in a washing process through control of the water supply valve. The water supply part may be configured to supply water into the tub 20 through the detergent supply device or to directly supply water into the tub 20 separately from the detergent supply device.

The detergent supply device may be connected to the water supply part through a water supply hose. That is, the detergent supply device may be configured to receive water from the water supply part and supply both detergents and water into the tub 20 or the drum 30.

Meanwhile, the laundry treatment apparatus 1 according to an embodiment of the present disclosure may include a drainage part, and the drainage part may be connected to the tub 20 to discharge water accommodated in the tub 20 to the outside.

FIG. 3 schematically illustrates the controller 60 provided inside the cabinet 10 according to an embodiment of the present disclosure. As described above, the controller 60 may be connected to a plurality of components, such as the driving part of the drum 30 and the control panel 100.

The controller 60 may be configured to perform a course for treating laundry based on a manipulation signal of the manipulation part. For example, upon receiving a course execution signal for laundry treatment through the manipulation part, the controller 60 may control the water supply part and the driving part to perform a corresponding course.

The controller 60 may be provided in a partial space of the cabinet 10 or may be provided inside the control panel 100. For example, the controller 60 may be provided in the form of a module and may be provided in a base located on a lower panel of the cabinet 10.

In addition, the controller 60 may be provided inside the control panel 100, for example, in a portion of the screen output part 8 or the manipulation part. In addition, the controller 60 may be composed of a plurality of segments. The segments may be provided in the control panel 100 and the base, respectively, and may be operated together with the control panel 100 and the base.

Referring to FIGS. 1 and 3, in an embodiment of the present disclosure, the controller 60 may be signally connected to a portable communication terminal 70 by the user. The communication terminal 70 may be separated from the cabinet 10 and may be independently movable. The communication terminal 70 may include a communication function and may be configured to be carried by the user.

For example, the communication terminal 70 may correspond to a mobile phone capable of being carried by the user. FIGS. 1 and 3 schematically illustrate the communication terminal 70 corresponding to the mobile phone.

However, in an embodiment of the present disclosure, the communication terminal 70 is not necessarily limited to the mobile phone and may be of various types capable of communicating directly or indirectly with the controller 60.

The controller 60 may be configured to communicate with the communication terminal 70 in various ways. That is, the controller 60 may be signally connected to the communication terminal 70 through various methods.

For example, the controller 60 may be directly connected to the communication terminal 70 through various methods capable of transmitting and receiving wireless signals, such as Wi-Fi, Bluetooth, and NFC, or may be indirectly connected using an intermediate means provided inside or outside the laundry treatment apparatus 1 to transmit and receive a communication signal.

For example, the controller 60, together with the communication terminal 70, may be connected to a Wi-Fi module provided inside or outside the laundry treatment apparatus 1 to transmit and receive a signal to and from the communication terminal 70 through the Wi-Fi module.

Alternatively, the controller 60 may be connected to the Wi-Fi module, etc., and may transmit and receive signals to a communication server corresponding to a terminal base station for communication of the communication terminal 70, thereby being signally connected to the communication terminal 70 through the communication server.

The communication methods of the controller 60 described above are purely an example for explaining an embodiment of the present disclosure and are not limited to the above content. According to an embodiment of the present disclosure, the controller 60 and the communication terminal 70 may be capable of directly or indirectly transmitting and receiving signals therebetween using various methods.

An application capable of exchanging information with the laundry treatment apparatus 1 may be installed in the communication terminal 70 of the user, and various information provided from the controller 60 may be transmitted to the application through an external server or may be directly transmitted through Bluetooth.

The user may check various information of the laundry treatment apparatus 1 or command the laundry treatment apparatus 1 to perform various setting and courses using the communication terminal 70 as well as the control panel 100 of the laundry treatment apparatus 1.

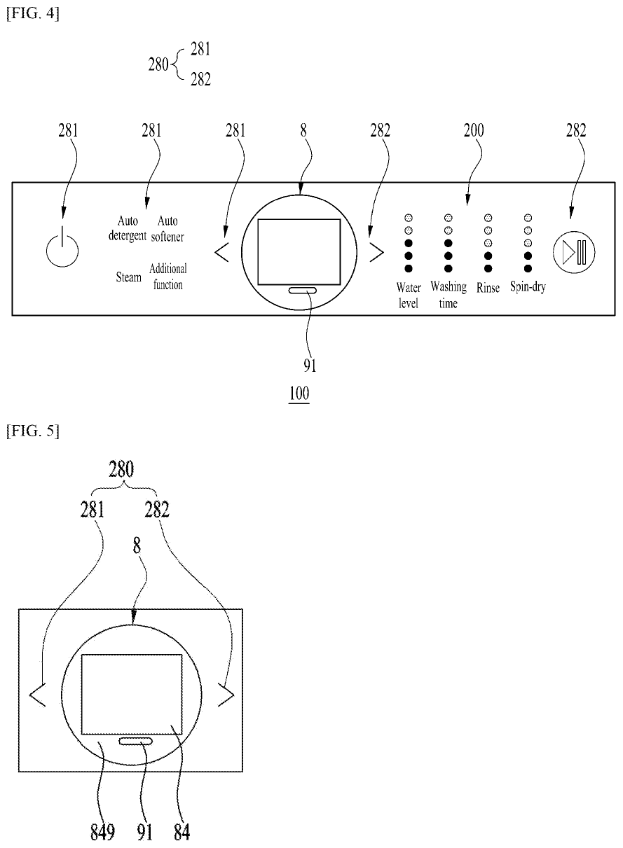

FIG. 4 is a diagram illustrating the control panel 100 in the laundry treatment apparatus 1 according to an embodiment of the present disclosure, and FIG. 5 is a diagram illustrating the screen output part 8 provided in the control panel 100 according to an embodiment of the present disclosure.

As described above, the laundry treatment apparatus 1 according to an embodiment of the present disclosure may be provided as the front-loading type as illustrated in FIG. 1 or the top-loading type as illustrated in FIG. 2. Hereinafter, for convenience of explanation, unless otherwise specified, the description will be based on the front-loading laundry treatment apparatus. However, it is apparent that the present disclosure is not limited to the front-loading laundry treatment apparatus and may be provided as the top-loading laundry treatment apparatus as illustrated in FIG. 2.

The laundry treatment apparatus 1 according to an embodiment of the present disclosure may include the cabinet 10, the drum 30, the screen output part 8, the movement button part 260, and the multi-function button part 91. The drum 30 is rotatably provided inside the cabinet 10, clothes are accommodated therein.

The screen output part 8 may be provided in the cabinet 10 and may be configured to output a screen on which a plurality of objects selectable by the user is displayed.

The movement button part 260 may be provided in the cabinet 10 and may be manipulated by the user to move a selection target indication displayed on any one of the plurality of objects. The multi-function button part 91 may be provided in the screen output part 8, and functions thereof may vary according to a screen output from the screen output part 8.

The movement button part 260 may include a first movement button part 261 and a second movement button part 262. The first movement button part 261 may move the selection target indication in one direction in a state in which a screen is output from the screen output part 8, and the second movement button part 262 may move the selection target indication in the other direction in a state in which a screen is output from the screen output part 8.

Referring to FIG. 4, the laundry treatment apparatus 1 according to an embodiment of the present disclosure may include the control panel 100 provided on the front panel 15. The control panel 100 may also be provided on a top panel or a side panel in addition to the front panel 15. Hereinafter, the description will be based on the case in which the control panel is provided on the front panel 15 unless otherwise specified.

The control panel 100 may include an output part for providing information to the user and an input part for allowing the user to input a manipulation signal to the controller 60. The output part may include the screen output part 8, and the input part may include the manipulation part.

The control panel 100 may be integrally provided with the front panel 15 or may be separately manufactured from the front panel 15 and may then be coupled and fixed to the front panel 15. When the control panel 100 is formed as a part of the front panel 15, a plurality of openings for exposing the manipulation part and the screen output part 8 to the outside may be formed in the control panel 100.

The control panel 100 may be positioned at the upper end part of the front panel 15 to secure a position that the user may easily manipulate or check. For example, the control panel 100 may be positioned on the side of the detergent opening 16 at the upper end part of the front panel 15 or may have a width corresponding to the front panel 15 to constitute the entire upper end part of the front panel 15.

Referring to FIG. 5, the screen output part 8 may be disposed in the center of the control panel 100. However, the position of the screen output part 8 is not necessarily limited thereto and may have various positions as needed.

The screen output part 8 may include the display 84 on which the screen is output and a screen circumference part 849 to which the display 84 is coupled and fixed. The screen circumference part 849 may correspond to a region surrounding the display 84.

The screen output part 8 may be positioned on the same plane as the control panel 100. That is, the screen output part 8 may constitute a part of the front surface of the cabinet 10 together with the control panel 100. The screen output part 8 may be connected to the controller 60 to output various screens under control of the controller 60.

In FIG. 4 and FIG. 4, the multi-functional button part 91 is illustrated. The multi-function button part 91 may correspond to a portion of the manipulation part and may have various functions that vary according to a screen output from the screen output part 8.

For example, in a course selection screen 410 to be described later, the multi-function button part 91 may have an option recommendation function and, in a course progress screen 510, the multi-function button part 91 may have a laundry addition function. According to an embodiment of the present disclosure, since the functions of the multi-function button part 91 vary according to the screen output from the screen output part 8, the number of buttons included in the manipulation part may be effectively reduced, and the user may conveniently manipulate the manipulation part.

The multi-function button part 91 may be provided in the screen circumference part 849. That is, the display 84 may be coupled and fixed to the inner side of the screen circumference part 849, and the multi-function button part 91 may be provided in the screen circumference part 849 so that the user may conveniently use the multi-function button part 91 while checking the screen.

Although FIG. 4 and FIG. 4 illustrate the multi-functional button part 91 as being located below the display 84, a specific position of the multi-function button part 91 may vary.

Meanwhile, at least borders of the screen output part 8 and the multi-function button part 91 may be configured to emit light. That is, the control panel 100 may have a light-emitting area along the borders of the screen output part 8 and the multi-function button part 91 to improve design satisfaction of the user.

For example, when power is applied to the laundry treatment apparatus 1 and the screen output part 8 operates, the border of the screen output part 8 may emit light to provide output of a screen to the user.

In addition, according to an embodiment of the present disclosure, the multi-function button part 91 may have functions changing according to a screen, and the activation and deactivation thereof may be determined according to the screen. That is, when the multi-function button part 91 does not have functions according to the screen output from the screen output part 8, the controller 60 may deactivate the multi-function button part 91. In this case, the border of the multi-function button part 91 may be extinguished.

Meanwhile, when the multi-function button part 91 is activated to execute functions, the controller 60 controls the control panel 100 so that the border of the multi-function button part 91 is illuminated, thereby enabling the user to effectively recognize availability of the multi-function button part 91.

The movement button part 260 may correspond to one configuration of the manipulation part and may be manipulated by the user to move the selection target indication displayed on any one of the plurality of objects. That is, the movement button part 260 may change a selection target object scheduled to be selected among the plurality of objects displayed on the screen to another object.

In the present disclosure, the selection target indication means displaying an object scheduled to be selected among a plurality of objects displayed in the screen output part 8, and the object on which the selection target indication is located corresponds to the selection target object that is scheduled to be selected and is selectable by the user.

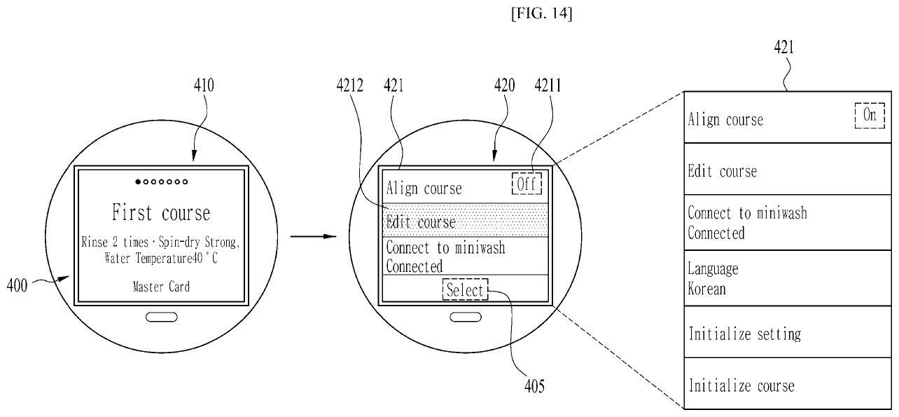

FIG. 14 illustrates a setting screen 420 output from the screen output part 8 according to an embodiment of the present disclosure, and a setting list 421 including a plurality of setting items may be displayed on the setting screen 420.

In the setting list 421, the above-described selection target indication is located on the selection target object. The selection target object on which the selection target indication is located has a different color or brightness from other items, so that the user may easily check an object to be currently selected.

In an embodiment of the present disclosure, the selection target indication may be implemented in various ways. For example, according to an embodiment of the present disclosure, in order to indicate various selection objects in a limited area of the display 84, which will be described later, only one of a plurality of objects may be displayed on the screen, and the user may manipulate the movement button part 260 to change the object displayed on the screen to another object.

In FIG. 10, the course selection screen 410 on which one of a plurality of courses is displayed on a screen is illustrated according to an embodiment of the present disclosure. In the course selection screen 410, the user may change a course displayed on the screen to another course using the movement button part 260. In this case, the selection target object may mean a course displayed currently on the screen, and the selection target indication may mean displaying only a course which is scheduled to be selected among the plurality of courses on the screen.

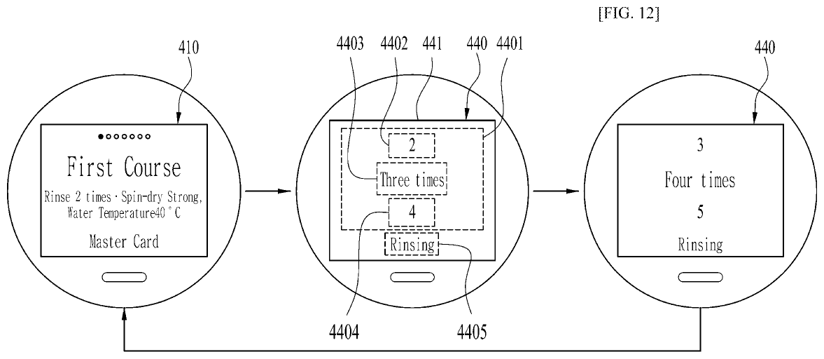

FIG. 12 illustrates an option screen 440 on which an option setting value for any one option is changed by the user. In the case of the option screen 440, an option value scheduled to be selected among the plurality of selection objects may have a larger text size and may be displayed in a brighter color.

That is, in an embodiment of the present disclosure, the selection target indication of the option screen 440 may mean that a text size of the option value is changed to be enlarged and a color of the option value is changed to have a brighter color among a plurality of objects.

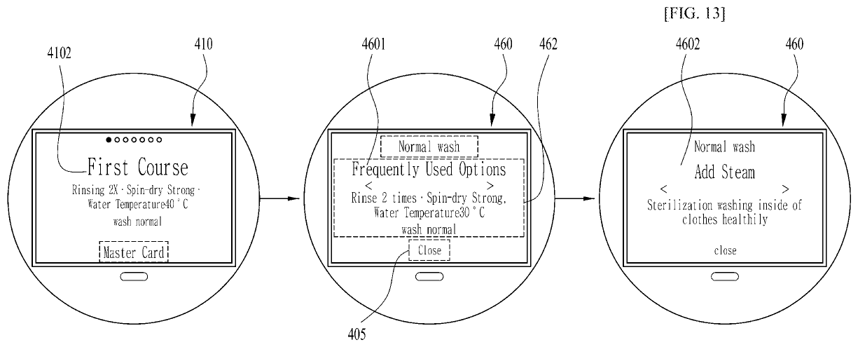

FIG. 13 illustrates an option recommendation screen 460 on which one of a plurality of option combinations is displayed according to an embodiment of the present disclosure. Similar to the course selection screen 410, the user may change an option combination displayed on the option recommendation screen 460 to another option combination using the movement button part 260.

That is, the selection target indication in the option recommendation screen 460 may mean displaying, on the screen, only an option combination scheduled to be selected among a plurality of option combinations as on the course selection screen 410.

As described above, in an embodiment of the present disclosure, the selection target indication for any one of the plurality of objects may be expressed in various ways. A detailed description of FIGS. 10, 12, and 13 will be given later.

Referring to FIGS. 4 and 5, the movement button part 260 may include the first movement button part 261 and the second movement button part 262. The first movement button part 261 may change the selection target object on the screen output from the screen output part 8 to an object of the next order among the plurality of objects. That is, the first movement button part 261 may move the selection target indication on the plurality of objects in one direction.

The second movement button part 262 may change the selection target object on the screen output from the screen output part 8 to an object of the previous order among the plurality of objects. That is, the second movement button part 262 may move the selection target indication on the plurality of objects in the other direction.

Specifically, according to an embodiment of the present disclosure, a plurality of selection objects may be presented to the user through the screen of the screen output part 8, and the user may directly select any one of various selection objects by manipulating the movement button part 260 to perform a subsequent procedure.

The first movement button part 261 may move the selection target indication in one direction, and the second movement button part 262 may move the selection target indication in the other direction. That is, the first movement button part 261 may change the selection target object in the next order, and the second movement button part 262 may change the selection target object in the previous order. Here, one direction may be variously defined according to a method in which a selection object is displayed on the screen output from the screen output part 8.

For example, when a plurality of objects is aligned in left and right directions in the screen output part 8, one direction may correspond to any one of a left direction and a right direction, and the other direction may be defined as an opposite direction of the one direction.

In addition, when a plurality of objects is aligned in a vertical direction in the screen output part 8, one direction may correspond to any one of upper and lower directions, and the other direction may be defined as an opposite direction of the one direction.

Further, when a plurality of objects is aligned along a circle or arc shape of the screen output part 8, one direction may be a clockwise direction or a counterclockwise direction, and the other direction may be an opposite direction of the one direction.

That is, in an embodiment of the present disclosure, a plurality of objects output in the screen output part 8 may be directionally aligned. The first movement button part 261 may move the selection target indication in one direction which is directionally defined, and the second movement button part 262 may move the selection target indication in the other direction.

According to an embodiment of the present disclosure, since the movement button part 260 may be manipulated in both one direction and the other direction, it not only allows the user to select a plurality of objects through the screen output part 8, but also efficiently improves convenience of manipulation in selecting the plurality of objects. Further, since various functions for each screen are implemented through the multi-function button part 91, convenience of use may be improved.

Meanwhile, the first movement button part 261 may be located on one side of the screen output part 8, and the second movement button part 262 may be located on the other side of the screen output part 8, based on the width direction of the cabinet 10.

In an embodiment of the present disclosure, the first movement button part 261 and the second movement button part 262 may be positioned on opposite sides of the screen output part 8 so that the user may easily visually recognize that the first movement button part 261 and the second movement button part 262 have movement functions in opposite directions.

Meanwhile, the movement button part 260 may be displayed in the form of lines bent toward opposite directions on the cabinet 10. That is, the movement button part 260 may be provided in the form of angle brackets. Accordingly, the user may easily recognize that the movement button part 260 has a function of directionality.

A specific shape of the movement button part 260 may vary. For example, as illustrated in FIG. 5, the movement button part 260 may be provided to imply directionality by bending one line or may be provided in a shape of arrows including angle brackets.

In an embodiment of the present disclosure, as described above, the screen output part 8 may include a border line extending along the border thereof, and the movement button part 260 may be located outside the border line.

That is, the movement button part 260 may be located outside the screen output part 8. As described above, the screen output part 8 may be provided such that the display 84 is disposed in the screen circumference part 849 and the border line is located on the border of the screen circumference part 849.

In an embodiment of the present disclosure, the screen output part 8 should provide various information to the user in a limited area of the display 84, and thus, it may be important to sufficiently secure the area of the display 84.

However, when the movement button part 260 is provided on the screen output part 8, the area of the display 84 for arrangement of detailed configurations of the movement button part 260 may be limited. Therefore, according to an embodiment of the present disclosure, the movement button part 260 may be disposed outside the screen output part 8 to maximally secure the area of the display 84.

In an embodiment of the present disclosure, the border line, the movement button part 260, and the circumference of the multi-function button part 91 may be provided to emit light, and the circumference of the multi-function button part 91 may be configured to emit light in a state in which a function of the multi-function button part 91 is activated.

As described above, in an embodiment of the present disclosure, the screen output part 8 may be configured such that the border line emits light. When a screen is output, the border line emits light to induce the user to recognize the screen.

In addition, since the movement button part 260 is also configured to emit light, the user may easily recognize the movement button part 260. The multi-function button part 91 also emits light so that the user may effectively recognize the multi-function button part 91.

However, the movement button part 260 and the multi-function button part 91 may be configured to emit light only when each of the movement button part 260 and the multi-function button part 91 is available, i.e., only when each of the movement button part 260 and the multi-function button part 91 is activated. Accordingly, the user may effectively recognize availability of a corresponding button.

As described above, in an embodiment of the present disclosure, the screen output part 8 includes the display 84 by which the screen is output and the screen circumference part 849 that surrounds and fixes the display 84, and the multi-function button part 91 may be provided in the screen circumference part 849.

In addition, the screen output part 8 may be provided on the front surface of the cabinet 10, and the multi-function button part 91 may be disposed below the display 84 in the screen circumference part 849.

In an embodiment of the present disclosure, the display 84 may be provided in a rectangular shape. The screen circumference part 849 may be provided in a circular shape and the display 84 may be fixed to the inside of the screen circumference part 849. The border line of the screen output part 8 described above may be provided to correspond to the outer circumference of the screen circumference part 849.

Meanwhile, the screen output part 8 may be configured to output a screen including a function display area 405 that displays a current function of the multi-function button part 91.

Specifically, in an embodiment of the present disclosure, the screen output part 8 may output a plurality of screens. Activation/deactivation of the multi-function button part 91 and functions of the multi-function button part 91 in the activated state may be changed according to a corresponding screen.

Accordingly, a screen output from the screen output part 8 may include the function display area 405 that indicates activation/deactivation of the multi-function button part 91 functions of the multi-function button part 91 to the user.

The function display area 405 may display the functions of the multi-function button part 91 on a currently displayed screen. In addition, the function display area 405 may be removed from the screen when the multi-function button part 91 is deactivated.

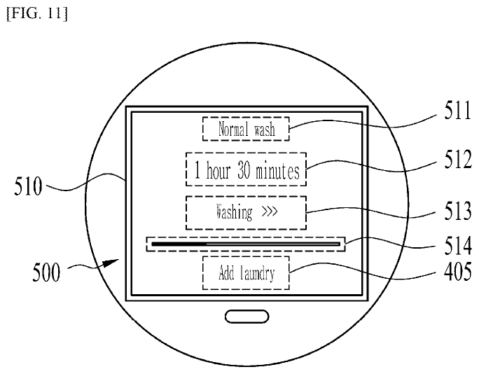

For example, FIG. 10 illustrates the course selection screen 410, and text indicating an option recommendation function of the multi-function button part 91 is displayed on the course selection screen 410. FIG. 11 illustrates a course progress screen 510 and text indicating a laundry addition function of the multi-function button part 91 is displayed in the function display area 405.

In FIG. 12, the option screen 440 is illustrated, and the function display area 405 may be removed from the option screen 440 due to deactivation of the multi-function button part 91. In FIG. 13, the option recommendation screen 460 is illustrated, and text indicating an option recommendation end function of the multi-function button part 91 is displayed in the function display area 405. In FIG. 14, the setting screen 420 is illustrated, and text indicating a selection function of the multi-function button part 91 is displayed in the function display area 405.

As described above, according to an embodiment of the present disclosure, the function display area 405 that indicates activation/deactivation of the multi-function button part 91 and the functions of the multi-function button part 91 is output on the screen of the screen output part 8, so that the user may conveniently check manipulation availability and functions of the multi-function button part 91 for each screen.

The screen output part 8, the multi-function button part 91, and the movement button part 260 may be provided not to protrude from the control panel 100. That is, the control panel 100 may form the screen output part 8 and the like to have a flat front surface so that the screen output part 8 and the like may not protrude therefrom.

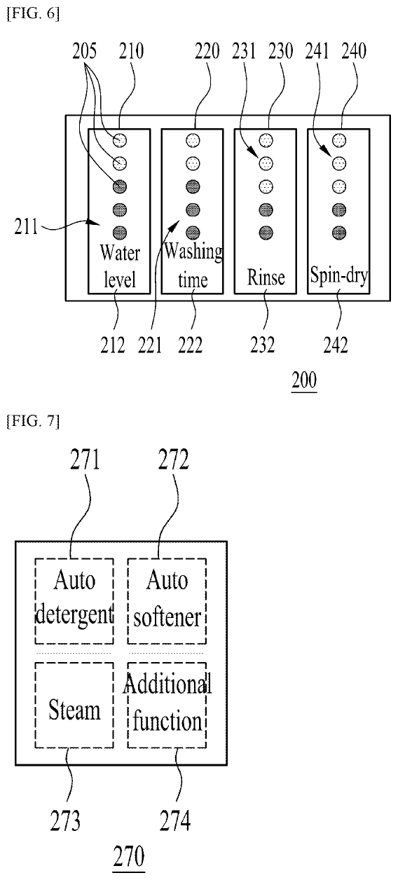

FIG. 6 illustrates a general option part 200 provided in the control panel 100. Referring to FIG. 6, the laundry treatment apparatus 1 according to an embodiment of the present disclosure may further include the general option part 200. The general option part 200 may be positioned on one side of the screen output part 8 based on a width direction of the cabinet 10 and may be manipulated by the user to adjust options of a course for treating laundry.

Specifically, according to an embodiment of the present disclosure, a plurality of courses for treating laundry may be prestored in the controller 60. The plurality of courses may include various courses having different characteristics, such as anormal wash course, anormal dry course, a spin-dry course, and a tub sterilization course.

Meanwhile, for each of the plurality of courses, a plurality of options may be adjusted. The plurality of options may include various adjustable objects in performing the course, such as water level, washing time, rinsing, spin-dry, water temperature, and the like. Each of the plurality of courses may have a plurality of options adjusted. The plurality of options may include various objects that is adjustable in performing the course, such as a water level, a washing time, rinsing, spin-drying, and a water temperature.

According to an embodiment of the present disclosure, the general option part 200 may be provided on one side of the screen output part 8 in the control panel 100, and the user may adjust the general option part 200 to perform a course set as an option desired by the user.

Referring to FIG. 4, the control panel 100 may extend in a width direction of the cabinet 10 and be provided on the front panel 15, and the screen output part 8 may be disposed in the center side of the control panel 100. The general option part 200 may be disposed on one side of the screen output part 8. That is, the screen output part 8 and the general option part 200 may be aligned in parallel in the width direction of the cabinet 10.

The general option part 200 may include a first option adjuster 210 and a second option adjuster 220. The first option adjuster 210 may be configured to adjust a first option of the course, and the second option adjuster 220 may be configured to adjust a second option of the course. The first option adjuster 210 and the second option adjuster 220 may be aligned in the width direction.

As described above, in an embodiment of the present disclosure, there may be a plurality of options adjusted for each course. For example, in an embodiment of the present disclosure, the options may include a first option, a second option, a third option, and the like. The number of options may vary as needed.

Meanwhile, the general option part 200 may include a plurality of option adjusters corresponding to a plurality of options. The plurality of option adjusters may correspond to different options, respectively. For example, the first option adjuster 210 may be configured to adjust the first option, the second option adjuster 220 may be configured to adjust the second option, and the third option adjuster 230 may be configured to adjust the third option. The number of option adjusters may correspond to the number of options.

In an embodiment of the present disclosure, the first option adjuster 210 and the second option adjuster 220 may be aligned in the width direction. In FIG. 6, according to an embodiment of the present disclosure, the general option part 200 includes the first option adjuster 210, the second option adjuster 220, the third option adjuster 230, and a fourth option adjuster 240, and the first to fourth option adjusters are aligned in the width direction of the cabinet 10.

The number of option adjusters illustrated in FIG. 6 is purely an example for explaining an embodiment of the present disclosure, and the number of option adjusters may be variously determined as needed.

According to an embodiment of the present disclosure, the user may set a plurality of options for a course for laundry treatment, and a plurality of option adjusters may be provided to enable the user to conveniently adjust the plurality of options. The plurality of option adjusters may be aligned in the width direction of the cabinet 10 to maintain a unified relationship between the extension direction of the control panel 100 and the screen output part 8, thereby increasing design completeness and allowing the user to easily distinguish and use each option adjuster.

In an embodiment of the present disclosure, the general option part 200 may include an option display part and an option button part. The option display part may display an option setting value of the option, and the option button part may adjust the option setting value of the option.

In an embodiment of the present disclosure, the general option part 200 may include a plurality of option adjusters, and each of the plurality of option adjusters may include the option display part and the option button part.

That is, the first option adjuster 210 may include a first option display part 211 and a first option button part 212, the second option adjuster 220 may include a second option display part 221 and a second option button part 222, the third option adjuster 230 may include a third option display part 231 and a third option button part 232, and the fourth option adjuster 240 may include a fourth option display part 241 and a fourth option button part 242.

The option display part included in the option adjuster may be configured to display an option setting value for a corresponding option. In an embodiment of the present disclosure, each option may include a plurality of option values. For example, a “rinse” option may include option values such as 1 time, 2 times, 3 times, etc.

Meanwhile, option setting values of each of the plurality of options may be stored in the controller 60. Each of the plurality of options may include a plurality of option values, and any one of the plurality of option values may be stored as an option setting value and reflected as a setting value of the corresponding option.

For example, in an embodiment of the present disclosure, a plurality of courses stored in the controller 60 may include a normal wash course, and a plurality of options may be adjusted in the normal wash course.

The plurality of options may include a “water level” option, and an option setting value of the water level option may be set to “middle”. In addition, the plurality of options may include “rinse” option, and an option setting value of the rinse option may be set to “two times”.

In this case, the controller 60 may perform the normal wash course in which the optional setting value of the water level option is middle and the optional setting value of the rinse option is two times. The plurality of options is adjustable by the user.

Meanwhile, the option display part may display an option setting value of a corresponding option. That is, the option display part may display any one of a plurality of option values included in a corresponding option as the option setting value. A method in which the option display part displays a plurality of option values and option setting values may vary.

The option button part may be provided to change an option setting value of a corresponding option. That is, when a manipulation signal of any one option button part is generated by the user, the controller 60 may change an option setting value of an option corresponding to the option button part.

That is, according to an embodiment of the present disclosure, the plurality of option adjusters for adjusting a plurality of options is provided, and each of the plurality of option adjusters may include an option display part and an option button part, so that the user may conveniently check an option setting value of each of the plurality of options and conveniently adjust each option setting value as needed.

In an embodiment of the present disclosure, the option button part may display the name of each corresponding option. In FIG. 6, according to an embodiment of the present disclosure, the control panel 100 is illustrated in which an option name is displayed on each of the first option button part 212, the second option button part 222, the third option button part 232, and the fourth option button part 242.

The control panel 100 may be provided such that the option button parts emit light. That is, according to an embodiment of the present disclosure, since the option button parts emit light to display option names, the user may easily recognize an option corresponding to each of the option button parts.

Meanwhile, the option display part includes a plurality of light emitting parts 205 aligned in parallel in one direction, and the plurality of light emitting parts 205 corresponds to a plurality of option values for a corresponding option, respectively. The option display part may cause the light emitting part 205 corresponding to an option setting value among the plurality of light emitting parts 205 corresponding to the plurality of option values to emit light, thereby providing information about the option setting value to the user.

The option display part may include the plurality of light emitting parts 205, and each of the plurality of light emitting parts 205 may correspond to an LED device that generates light through power consumption. The plurality of light emitting parts 205 may be aligned in one direction.

For example, as illustrated in FIG. 6, the plurality of light emitting parts 205 may be aligned in a direction away from the option button part. The plurality of light emitting parts 205 may be aligned above the option button part.

In an embodiment of the present disclosure, the plurality of option adjusters may be aligned in the width direction of the cabinet 10, and the plurality of light emitting parts 205 may be aligned in a direction crossing the width direction of the cabinet 10. Therefore, each configuration of the option adjusters may be efficiently arranged.

The number of the light emitting parts 205 may correspond to the number of option values of each option. That is, the plurality of light emitting parts 205 in one option adjuster may correspond to different option values, respectively.

The option display part may be configured to cause the light emitting part 205 corresponding to an option value set as a current option setting value among the plurality of light emitting parts 205 to emit light. Therethrough, the user may check the light emitting part 205 that emits light, thereby effectively identifying an option setting value of a corresponding option.

Referring to FIG. 6, in an embodiment of the present disclosure, the option button part may be disposed at a lower end part of the option adjustor, and the plurality of light emitting parts 205 may be aligned above the option button part.

In addition, option values of each option may include a minimum value and a maximum value. Among the plurality of light emitting parts 205, the light emitting part 205 located at a relatively higher position may correspond to a higher option value. For example, the light emitting part 205 disposed at the lowermost end among the plurality of light emitting parts 205 may correspond to the minimum value among the option values, and the light emitting part 205 disposed at the uppermost end may correspond to the maximum value among the option values.

Meanwhile, the option display part may be configured such that the light emitting parts 205, including the light emitting part 205 corresponding to a current option setting value starting from the lowermost light emitting part 205, to emit light. For example, when the current option setting value is the minimum value, the option display part may cause the lowermost light emitting part 205 to emit light, and when the current option setting value is the maximum value, the option display part may cause the entirety of the plurality of light emitting parts 205 to emit light.

In this case, the option setting value in the option display part may be displayed as the height at which the plurality of light emitting parts 205 emit light, and the user may effectively recognize the level of a current option setting value from the entire option values through the height at which the plurality of light emitting parts 205 emit light in the option display part.

In an embodiment of the present disclosure, the controller 60 may be configured to control the rotation of the drum 30 and perform the course. A plurality of courses may be stored in the controller 60, and an option group settable by the user with respect to each of the plurality of courses may be preset.

The option display part and the option button part may be configured to emit light together. The option display part and the option button part may emit light together based on the option group for a course currently displayed in the screen output part 8.

That is, in an embodiment of the present disclosure, only option adjusters corresponding to adjustable options with respect to the currently displayed course among the plurality of option adjusters may emit light, and the remaining option adjusters may be extinguished, so that the user may easily determine which options may be adjusted.

Specifically, one of a plurality of courses may be selectively displayed on the course selection screen 410, and the user may change the course displayed on the course selection screen 410 through the above-described movement button part 260 and adjusts an option of the currently displayed course through the option adjuster.

However, as described above, each of the plurality of courses has different characteristics, and thus adjustable options for each course may be different.

For example, in an embodiment of the present disclosure, the plurality of courses may include a normal wash course, and the normal wash course may include a plurality of options. In addition, the plurality of courses may include a spin-dry course. However, due to the nature of the spin-dry course that only performs spin-dry, options other than a “spin-dry” option for controlling the number of times of spin-dry may be configured not to be adjustable.

Furthermore, the plurality of courses may include a “tub sterilization” course for cleaning the inside of the drum 30, and the tub sterilization course may be set such that no options are changeable because the tub sterilization course is not intended for direct laundry treatment.

As described above, in an embodiment of the present disclosure, the plurality of courses may have different adjustable options depending on characteristics thereof, and therefore, adjustable options for each course may be preset in the controller 60 as an option group. The option group may vary according to each course.

Meanwhile, in order for the user to select any one of the plurality of courses, in a state in which the course selection screen 410 on which the plurality of courses is selectively displayed is output from the screen output part 8, the controller 60 may control the control panel 100 so that option adjusters corresponding to an option group of a course currently displayed in the screen output part 8 emit light, and the remaining option adjusters are extinguished. Accordingly, the user may effectively recognize adjustable options in the corresponding course.

FIG. 7 illustrates an additional option part 270 provided in the control panel 100 according to an embodiment of the present disclosure. In an embodiment of the present disclosure, the output part may include the screen output part 8, and the manipulation part manipulated by the user may include the movement button part 260, the option part, and the additional option part 270.

The additional option part 270 may be located on the other side of the screen output part 8 based on the width direction and may be manipulated by the user. The additional option part 270 may be configured to adjust additional options other than options corresponding to the general option part 200.

In an embodiment of the present disclosure, the options adjusted through the general option part 200 reflect one of a plurality of option values as an option setting value, whereas the additional options settable in the additional option part 270 may correspond to options simply indicating whether or not to select the corresponding options instead of the plurality of option values.

For example, the additional option part 270 may include an “automatic detergent” option, a “softener” option, a “steam” option, and a “set” option. For example, an additional option, such as the steam option, is configured only to determine whether or not to use steam and may not have a plurality of option values. In addition, an additional option, such as the set option is configured only to determine whether or not to enter the set screen 420 and may not have a plurality of option values.

According to an embodiment of the present disclosure, options, an option setting value of which is set to one of a plurality of option values, may be configured to be adjustable through the general option part 200 having the option display part, and options, only entry or reflection of which is simply selectable, may be configured to be selectable through the additional option part 270.

The additional option part 270 may be located on the other side of the screen output part 8 based on the width direction of the cabinet 10. That is, the additional option part 270 may be positioned on the opposite side of the general option part 200 based on the screen output part 8.

One side on which the general option part 200 is positioned and the other side on which the additional option part 270 is located are only presented as a relative concept therebetween, and this may be understood to include all states in which the general option part 200 and the additional option part 270 are positioned on opposite sides of the screen output part 8 interposed therebetween.

In an embodiment of the present disclosure, since the general option part 200 and the additional option part 270 are positioned on opposite sides of the screen output part 8 in the width direction of the cabinet 10, a space on the control panel 100 extending in the width direction of the cabinet 10 may be effectively utilized, and uniformity of the arrangement may be secured to effectively improve design completeness.

Meanwhile, in an embodiment of the present disclosure, as the general option part 200 and the additional option part 270 are positioned on opposite sides of the screen output part 8, options adjusted through the general option part 200 and options selected through the additional option part 270 may be conveniently distinguished conceptually.

In an embodiment of the present disclosure, the screen output part 8 and the movement button part 260 may be disposed between the general option part 200 and the additional option part 270 based on the width direction of the cabinet 10.

That is, the screen output part 8 may be disposed between the general option part 200 and the additional option part 270, and the first movement button part 261 may be disposed between the screen output part 8 and the additional option part 270. The second movement button part 262 may be disposed between the screen output part 8 and the general option part 200. Alternatively, the second movement button part 262 may be disposed between the screen output part 8 and the additional option part 270, and the first movement button part 261 may be disposed between the screen output part 8 and the general option part 200.

In an embodiment of the present disclosure, since the movement button part 260 having a directivity-related function is disposed on both sides of the screen output part 8, and the general option part 200 and the additional option part 270 are disposed on both sides of the screen output part 8 and the movement button part 260, uniformity between an extension direction of the control panel 100 and an arrangement direction of each component may be secured to improve design completeness and improve space utilization on the control panel 100.

In an embodiment of the present disclosure, the additional option part 270 may include a plurality of additional option button parts through which different additional options are adjusted, and the plurality of additional option button parts may be arranged in a grid form.

For example, the additional option button parts may include a first additional option button part 271, a second additional option button part 272, a third additional option button part 273, and a fourth additional option button part 274. The specific number of the additional option button parts may vary as needed.

As described above, unlike the options adjusted in the general option part 200, the additional option button part is only to determine whether or not to select or enter an option, and thus does not require an option display part. Therefore, in order to efficiently arrange a plurality of buttons, the additional option button parts may be arranged in a grid form, thereby improving arrangement efficiency.

Each of the additional option button parts may be configured to display the name of a corresponding additional option and to emit light based on an additional option which is settable in the course displayed in the screen output part 8.

As described above, whether a plurality of options is adjustable may be different according to characteristics of a plurality of courses. This may be equally applied to the additional options. For example, any one of the additional option button parts may correspond to a “steam” option, and the steam option may not be applied to a spin-dry course intended for a simple spin-dry process.

Accordingly, in an embodiment of the present disclosure, each of the plurality of additional option button parts may be configured to emit light. The controller 60 may control only selectable additional option button parts among the plurality of additional option button parts to be illuminated and the remaining additional option button parts to be extinguished, with respect to a course that is currently displayed in the screen output part 8 and is to be selected by the user. Therefore, the user may conveniently identify currently selectable additional options.

Further, in an embodiment of the present disclosure, the names of additional options corresponding respectively to the plural additional option button parts may be displayed on buttons. That is, the control panel 100 may be configured to display the name of the additional option on each of the additional option button parts, and each of the additional option button parts may be provided therein with an LED device, illumination and extinction of which is controlled by the controller 60.

In an embodiment of the present disclosure, the manipulation part may further include a power button part 281 and an execution button part 282 provided in the cabinet 10. The laundry treatment apparatus 1 according to an embodiment of the present disclosure may further include the power button part 281 and the execution button part 282 provided in the cabinet 10. The screen output part 8, the movement button part 260, the general option part 200, and the additional option part 270 may be disposed between the power button part 281 and the execution button part 282 based on the width direction.

When the user manipulates the power button part 281, power may be supplied to each component of the laundry treatment apparatus 1 according to an embodiment of the present disclosure, and when the user manipulates the execution button part 282, a laundry treatment process P3 for a course currently displayed in the screen output part 8 may be performed.

In a power-off state, the controller 60 may stand by in a sleep state in which the controller 60 may receive a signal from the power button part 281. When a power signal is transmitted from the power button part 281, the controller 60 may switch to a sleep-on state to control the laundry treatment apparatus 1 so as to supply power to each component of the laundry treatment apparatus 1.

The user may command the laundry treatment apparatus 1 to perform the laundry treatment process P3 by manipulating the execution button part 282. The execution button part 282 may be provided as a touch or mechanical button type, and when manipulated by the user, generates an execution signal, which is a type of manipulation signal. When the execution signal is transmitted in the sleep-on state, the controller 60 may control the driving part and the water supply part to perform the laundry treatment process P3 for treating laundry.

Meanwhile, in using the laundry treatment apparatus 1 according to an embodiment of the present disclosure, the power button part 281 and the execution button part 282, which are necessarily manipulated by the user and have high importance, are independently disposed with respect to the screen output part 8 and the option part, so that the user can easily recognize the power button part 281 and the execution button part 282.

The power button part 281 and the execution button part 282 may be disposed in the remaining areas except for the screen output part 8 and the option part in the control panel 100. The power button part 281 and the execution button part 282 may be disposed on both sides of the screen output part 8, respectively.

In an embodiment of the present disclosure, the power button part 281 and the execution button part 282 may be disposed separately from the general option part 200 and the additional option part 270. Since the power button part 281 and the execution button part 282 have functions that are indispensably or most frequently used in the use of the laundry treatment apparatus 1 according to an embodiment of the present disclosure, the power button part 281 and the execution button part 282 may be configured to be distinguished from the general option part 200 and the additional option part 270.

The power button part 281 and the execution button part 282 may be located at the outermost parts of the control panel 100 based on the width direction of the cabinet 10. That is, the power button part 281 may be positioned at one end part of the control panel 100, and the execution button part 282 may be positioned at the other end part of the control panel 100. Alternatively, the execution button part 282 may be positioned at the one end of the control panel 100 and the power button part 281 may be positioned at the other end of the control panel 100.

In an embodiment of the present disclosure, since the power button part 281 and the execution button part 282 are located at the outermost parts of the control panel 100, all of the screen output part 8, the movement button part 260, the general option part 200, and the additional option part 270 may be located between the power button part 281 and the execution button part 282.

The power button part 281 and the execution button part 282 may be disposed at end parts of the control panel 100, respectively, and thus the user may easily recognize and use the power button part 281 and the execution button part 282 that are indispensable and have high frequency of use.

In an embodiment of the present disclosure, the movement button part 260, the power button part 281, and the execution button part 282 may be arranged in parallel in the width direction to improve design completeness. The control panel 100 may have a bar-shaped plate shape extending in the width direction of the cabinet 10.

In an embodiment of the present disclosure, the multi-function button part 91 may be provided inside the screen output part 8, and the movement button part 260 may be provided outside the screen output part 8. Accordingly, the multi-function button part 91, functions of which are changed according to a screen output from the screen output part 8, is provided on the screen output part 8 so that the user may check the screen and conveniently check and use the functions of the multi-function button part 91. The movement button part 260 is separately provided outside the screen output part 8, thereby minimizing unnecessary waste of space in the screen output part 8 and effectively increasing the area of the display 84.

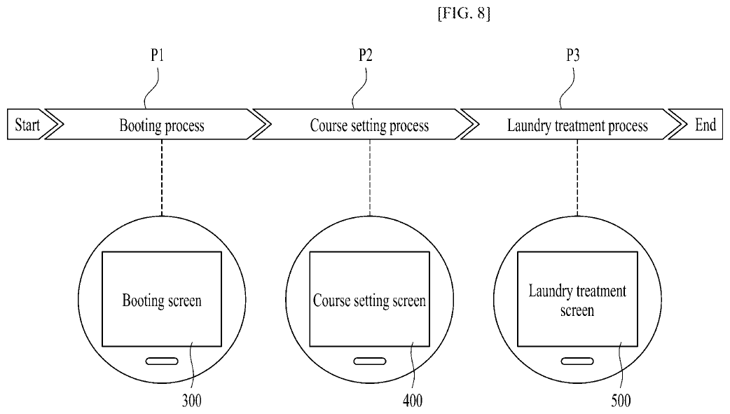

FIG. 8 is a diagram schematically illustrating change in screens output from the screen output part 9 according to an operation process of the laundry treatment apparatus 1 according to an embodiment of the present disclosure.

An operation process of the laundry treatment apparatus 1 according to an embodiment of the present disclosure may include a booting process P1, a course setting process P2, and a laundry treatment process P3. The booting process P1 corresponds to a process in which power is input to each component of the laundry treatment apparatus 1 and a program stored in the controller 60 is booted.

The course setting process P2 corresponds to a process in which one of a plurality of courses for treating laundry is selected by the user and various setting for the course is performed.

The laundry treatment process P3 corresponds to a process in which laundry is treated according to the course determined in the course setting process P2. In the laundry treatment process P3, the controller 60 controls the driving part or other components to perform the course.

The screen output part 8 may output a booting screen 300 in the booting process P l. The booting screen 300 may provide various information to the user in the booting process PT. For example, the booting screen 300 may provide various information such as current temperature, weather, booting progress status, warning content, and notification content to the user.

That is, the controller 60 may control the screen output part 8 to output the booting screen 300 and cause the booting screen 300 to provide various information related to the use of the laundry treatment apparatus 1 to the user.

The screen output part 8 may output a course setting screen 400 through the display 84 in the course setting process P2. The course setting screen 400 may provide information about various courses and setting to the user, and the user may set courses and options through the course setting screen 400.

For example, a plurality of courses for treating laundry is previously stored in the controller 60, and the controller 60 may control the screen output part 8 to output the course selection screen 410 for displaying the plurality of courses on a screen.

In addition, when the user manipulates the manipulation part through a screen displayed on the display 84, the controller 60 may perform the laundry treatment process P3 according to a course or setting displayed on the display 84 based on a manipulation signal of the manipulation part.

Meanwhile, the screen output part 8 may output a laundry treating screen 500 through the display 84 in the laundry treatment process P3. The laundry treating screen 500 may provide various information about a currently ongoing course to the user.

For example, the controller 60 may control the screen output part 8 to output the laundry treating screen 500 and provide various information, such as the name of the course currently in progress, a course execution time, a current treatment process in the corresponding course, and a remaining time to the user.

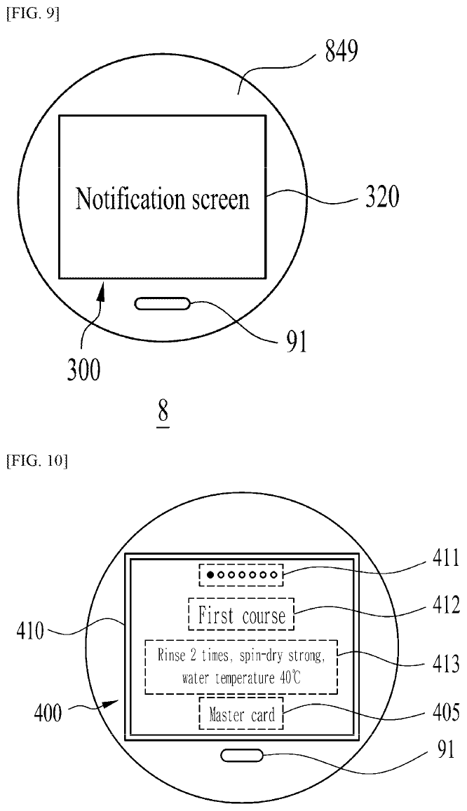

FIG. 9 is a diagram schematically illustrating a notification screen 320 out of the booting screen 300 output from the screen output part 8 according to an embodiment of the present disclosure.

In an embodiment of the present disclosure, the screen output part 8 may provide various information to the user in a preparation process of each configuration of the laundry treatment apparatus 1 through the booting screen 300. The booting screen 300 may include a plurality of screens that provide different information. In an embodiment of the present disclosure, the notification screen 320 illustrated in FIG. 9 may correspond to a part of the booting screen 300.

Various information may be displayed on the notification screen 320 and be visually provided to the user. The notification screen 320 may display various information prior to using the laundry treatment apparatus 1, such as current weather, temperature, water temperature, and remaining amount of detergent, etc.

In FIG. 10, the course selection screen 410 out of the course setting screen 400 output from the screen output part 8 is illustrated.

In an embodiment of the present disclosure, the course setting screen 400 output from the screen output part 8 may include various screens such as the course selection screen 410. That is, the course selection screen 410 may correspond to a part of the course setting screen 400 output from the screen output part 8.

FIG. 10 illustrates the course selection screen 410 as an example of the course setting screen 400 according to an embodiment of the present disclosure. The course selection screen 410 may display a plurality of courses for treating laundry, and any one of the plurality of courses may be selected through manipulation of the movement button part 260 by the user.

The course selection screen 410 may include an order display area 411, a course name area, an option guidance area 413, and a function display area 405. The order display area 411 is an area that displays the order of the currently displayed course among a plurality of courses to be displayed for the user through the course selection screen 410.

In an embodiment of the present disclosure, a plurality of courses for treating laundry may be prestored in the controller 60 and the plurality of courses is displayed through the screen output part 8 to allow the user to directly select any one of the plurality of courses.

However, the screen output part 8 may display information in a limited area through the display 84, and accordingly, simultaneously displaying the plurality of courses may be inefficient. In an embodiment of the present disclosure, since the plurality of courses may be displayed one by one in order on the course selection screen 410, the plurality of courses may be effectively displayed in the limited screen area.

According to the above circumstances, in an embodiment of the present disclosure, the course selection screen 410 includes the order display area 411 to inform the user in what order the currently displayed course is among the plurality of courses, and the user may conveniently check order information of the currently displayed course among the plurality of courses through the order display area 411.

In FIG. 10, multiple circular objects corresponding to the courses are displayed in the order display area 411, and a circular object corresponding to the course currently displayed on the course selection screen 410 has illuminance intensity different from illumination intensity of the remaining circular objects, thereby indicating the order of the currently displayed course to the user. However, the specific shape of the order display area 411 may be determined in various ways that may indicate the order of the current course with respect to the plurality of courses.

Meanwhile, the name of the course currently displayed on the course selection screen 410 may be displayed in the course name area. The user may identify the currently displayed course through the course name area.

An option setting value for the currently displayed course may be displayed in the option guidance area 413. As described above, a plurality of courses may each has a plurality of options set by the user, and each option has a plurality of option values that may be selected by the user. One of the plurality of option values may be designated as an option setting value for the option and reflected in the execution of the course.

According to an embodiment of the present disclosure, option setting values of a plurality of options for a corresponding course may be displayed through the option guidance area 413 of the course selection screen 410 so that the user may conveniently check a current option setting state for the corresponding course on the course selection screen 410 displaying the course.

Meanwhile, a current function of the multi-function button part 91 according to a screen currently displayed in the screen output part 8 may be displayed in the function display area 405. Accordingly, the user may conveniently and intuitively check a result obtained when manipulating the multi-function button part 91 for each screen.

In an embodiment of the present disclosure, content for indicating entry into the option recommendation screen 460 may be displayed in the function display area 405 of the course selection screen 410, and specific details about the option recommendation screen 460 will be described later.

In an embodiment of the present disclosure, a plurality of areas is efficiently configured such that various information may be effectively and conveniently transmitted to the user even in a limited output area in the course selection screen 410.

In an embodiment of the present disclosure, a plurality of courses for treating laundry may be stored in the controller 60. Whether to designate each of the plurality of courses as a display group to be displayed on the course selection screen 410 may be set, and whether to designate each course as the display group may be changed by the user.

Referring to FIG. 10, dot areas corresponding respectively to multiple courses designated as the display group may be displayed in the order display area 411. The total number of dot areas may be the same as the total number of courses designated as display groups, and a dot area corresponding to a currently displayed course may be expressed at brightness different from brightness of the other dot areas.

The order display area 411 may be located at an upper end of the display 84, and a selection course display area 412 may be located below the order display area 411. The selection course display area 412 may be located approximately in the center of the display 84.

The name of the currently displayed course may be displayed in the selection course display area 412 and has the largest text size in relation to other areas to ensure user visibility.

The option guidance area 413 may be placed below the selection course display area 412. The option guidance area 413 is located in the center of the display 84 together with the selection course display area 412 but may be located below the selection course display area 412.

An option setting value of each of a plurality of options may be displayed in the option guidance area 413. The name of each of the options and an option setting value of each option may be displayed in the option guidance area 413.

Text displayed in the option guidance area 413 may be displayed in a smaller size than text displayed in the selection course display area 412 and may be displayed at lower brightness than text displayed in the selection course display area 412.

The function display area 405 may be located below the option guidance area 413. The function display area 405 may be located at a lower end of the display 84. Text displayed in the function display area 405 may be displayed in a lower size than text displayed in the selection course display area 412.

In a state in which the course selection screen 410 is displayed in the screen output part 8, the user may change a course displayed on the screen by manipulating the movement button part 260. That is, the course displayed on the course selection screen 410 may correspond to a course on which a selection target indication is located among a plurality of courses.

The plurality of courses may have a display order. The user may manipulate one of the first movement button part 261 and the second movement button part 262 in order to output a course corresponding to the next order on the screen and manipulate the other one of the first movement button part 261 and the second movement button part 262 in order to output a course corresponding to the previous order.

In the course selection screen 410, the user may set various options by manipulating objects controlled to emit light by the controller 60 among a plurality of option adjusters included in the general option part 200 and a plurality of additional option button parts included in the additional option part 270.

In addition, in the course selection screen 410, the user may cause the laundry treatment apparatus 1 to perform the laundry treatment process P3 for performing a course currently displayed on the course selection screen 410 by manipulating the execution button part 282. The user may enter the option recommendation screen 460 on the course selection screen 410 by manipulating the multi-function button part 91. A detailed description of the option recommendation screen 460 will be given later.

FIG. 11 illustrates the course progress screen 510 out of the laundry treatment screen 500 output from the screen output part 8 according to an embodiment of the present disclosure. That is, the course progress screen 510 corresponds to a part of the laundry treatment screen 500, and the course progress screen 510 is illustrated as an example of the laundry treatment screen 500 in FIG. 11.

Through the course selection screen 410 of the screen output part 8, the user may check various information about a course for treating laundry. If the user specifies any one course through the movement button part 260 and the execution button part 282, the controller 60 may cause the laundry treatment apparatus 1 to perform the course specified by the user based on manipulation signals of the movement button part 260 and the execution button part 282.

A plurality of courses for treating laundry may include a normal wash course for washing clothes or a normal dry course for drying clothes. When the user selects any one of the normal wash course and the normal dry course, the controller 60 may control the water supply part, the driving part, the air supply part, the drainage part, and the like to cause the laundry treatment apparatus 1 to perform the corresponding course.

In the laundry treatment process P3 for performing the corresponding course, the controller 60 may control the screen output part 8 to output the course progress screen 510 and provide the user with various information about the laundry treatment process P3 which is currently in progress through the course progress screen 510.

Referring to FIG. 11, in an embodiment of the present disclosure, the course progress screen 510 may include an execution course display area 511, an execution time display area 512, an execution process display area 513, an execution completion degree display area 514, and the function display area 405. However, the configuration of the course progress screen 510 is not necessarily limited as described above and may vary as needed.

The execution course display area 511 is an area for displaying the name of a course being performed in the laundry treatment process P3, and the user may identify the course currently in progress through the execution course display area 511.

The execution time display area 512 is an area for displaying an execution elapsed time or remaining time of the course currently being performed, and the user may conveniently check to which degree the course being performed has been performed or check the completion time of the course currently being performed through time information displayed in the execution time display area 512.

The execution process display area 513 is an area for displaying a current treatment process of the course currently being performed. In an embodiment of the present disclosure, a course for treating laundry may include a plurality of treating processes. For example, a normal wash course may include a water supply process, a detergent input process, a washing process, a rinsing process, a drainage process, and a spin-drying process.

That is, in an embodiment of the present disclosure, when any one course is performed, a plurality of treatment processes for the corresponding course may be performed. The controller 60 may display a currently ongoing treatment process through the execution process display area 513 of the course progress screen 510, thereby allowing the user to secure intuition with respect to the laundry treatment process P3 and effectively check the current treatment process.

On the other hand, the execution completion degree display area 514 is an area that displays the degree to which progress has been performed so far for the entire course currently in progress. The execution completion degree display area 514 may display the completion degree by being converted into percentage or display the completion degree in the form of a bar as illustrated in FIG. 13.

According to an embodiment of the present disclosure, the user may simply and effectively check the progress completion degree of the course currently in progress through the execution completion degree display area 514. In addition, unlike the time display area for displaying only the remaining time, the execution completion degree display area 514 that displays the current process among all processes of the course may provide convenience to the user.

Meanwhile, the course progress screen 510 of the laundry treatment screen 500 may include the function display area 405 for displaying the functions of the multi-function button part 91 like the course selection screen 410 described above. That is, the multi-function button part 91 may be activated on the course progress screen 510.

When the multi-function button part 91 is activated, the multi-function button part 91 itself or a part of the screen output part 8, for example, a border area of the multi-function button part 91, may emit light to effectively indicate availability of the multi-function button part 91 to the user.

Each function of the manipulation part in the course progress screen 510 will be described as follows.

When the user manipulates the execution button part 282 in the course progress screen 510, the controller 60 may enter a pause state, and the screen output part 8 may output a pause screen. After the user temporarily stops the laundry treatment process P3 as needed, when the user manipulates the execution button part 282 again, the controller 60 may return to the laundry treatment process P3 which is a state immediately before the pause.

When the user manipulates the multi-function button part 91 in the course progress screen 510, the controller 60 may enter a laundry addition process, and the screen output part 8 may output a laundry addition screen. However, among a plurality of processes included in the course, the controller 60 may first determine whether a process currently in progress among the plurality of processes is a process to which the laundry addition process is applicable. If the process currently in progress corresponds to the process to which the laundry addition process is applicable, the controller 60 may activate the multi-function button part 91.

Accordingly, the function display area 405 for displaying the functions of the multi-function button part 91 may be displayed or removed in or from the course progress screen 510 according to the currently ongoing process.

FIG. 12 illustrates an option screen 440 output from the screen output part 8 according to an embodiment of the present disclosure. As described above, the laundry treatment apparatus according to an embodiment of the present disclosure may include the option button part. The option button part may be provided in the cabinet 10 and be manipulated by the user to adjust option values for each of a plurality of courses.

The screen output part 8 may be configured to output the course selection screen 410 that displays one of a plurality of courses for treating laundry. If the option button part is manipulated in the course selection screen 410, the course selection screen 410 may be switched to the option screen 440, and option values of the course displayed on the course selection screen 410 may be displayed on the option screen 440.

The option button part may be configured to change an option setting value for the corresponding option. That is, when the user manipulates the option button part, an option value corresponding to an option setting value of the corresponding option may be changed to another option value.

For example, when the option button part is provided with respect to a rinsing recovery option, the rinsing recovery option may have a plurality of option values, such as one time, two times, three times, and the like. When the option button part is manipulated in the case in which the option setting value of the rinsing recovery option is one time, the option setting value of the rinsing recovery option may be changed to two times, three times, or the like corresponding to another option value.

Meanwhile, an option corresponding to the option button part may be applied to each course. That is, the option button part may be configured to change an option setting value of a corresponding option with respect to each of the plurality of courses.

When the option button part is manipulated in the course selection screen 410, the screen output part 8 may output the option screen 440. That is, when the option button part is manipulated, the screen output part 8 may be switched from the course selection screen 410 to the option screen 440.

A plurality of option values for a corresponding option may be displayed on the option screen 440. In a state in which the option screen 440 is output, the user may select any one of the plurality of option values and set the selected option value as an option setting value of the corresponding option.

For example, in a state in which the course selection screen 410 is output from the screen output part 8 in the course setting process P2, the user may output the option screen 440 by manipulating any one of a plurality of option buttons.

A plurality of option values may be displayed on the option screen 440. The user may set any one of the plurality of option values as an option setting value by manipulating the movement button part 260 or adjust the option setting value by repeatedly manipulating the option button part in a state in which the option screen 440 is output.

In an embodiment of the present disclosure, when the option button part is manipulated, the screen output part 8 outputs the option screen 440 that displays a change in the option setting value for the corresponding option, thereby providing convenience for option setting to the user.

In an embodiment of the present disclosure, the screen output part 8 may be switched from the course selection screen 410 to the option screen 440 in the entire area of the display 84 on which a screen is output. Accordingly, the limited area of the display 84 may be utilized as much as possible, and a plurality of screens may be efficiently provided to the user.

Meanwhile, in an embodiment of the present disclosure, the screen output part 8 may be switched from the course selection screen 410 to the option screen 440 through a pop-up method. In an embodiment of the present disclosure, the pop-up method means that a new screen is displayed as if the screen pops out from an existing screen. According to the pop-up method, it may be understood that the new screen is stacked in the form of a kind of layer on the existing screen.

In the course setting process P2, the screen output part 8 may be configured to output the course setting screen 400. The course setting screen 400 may include the course selection screen 410 and the option screen 440, and the option screen 440 may be output from the course selection screen 410 in the pop-up method.

In an embodiment of the present disclosure, the option button part includes the first option button part 212 for adjusting a first option and the second option button part 222 for adjusting a second option. When the first option button part 212 is manipulated on the course selection screen 410, the screen output part 8 may be switched to a first option screen 441 on which an option value of the first option is displayed, and when the second option button part 222 is manipulated, the screen output part 8 may be switched to a second option screen on which an option value of the second option is displayed.

That is, in an embodiment of the present disclosure, the screen output part 8 may output a different screen for each option. When the first option button part 212 is manipulated, the screen output part 8 may output the first option screen 441 on which an option value of the first option is displayed. When the second option button part 212 is manipulated, the screen output part 8 may output the second option screen.

However, the rinsing recovery and the washing intensity described as the first option and the second option are only examples for the description of the present disclosure, and the first option and the second option may be determined as options other than the rinsing recovery and the washing strength.

Meanwhile, the above-described course selection screen 410 may include the option guidance area 413 in which option setting values of a currently displayed course are displayed. The option screen 440 may include an option value display area 4401 in which an option setting value of a corresponding option and at least some of a plurality of option values are displayed together.

FIG. 12 illustrates the option screen 440 on which a plurality of option values is displayed. As described above, the option button part may include a plurality of button parts, such as the first option button part 212, the second option button part 222, and the third option button part 232. In an embodiment of the present disclosure, an option value may be configured in various types including as a text type representing strength as well as a number type representing the number of times.

For each option, any one of a plurality of option values may be stored as an option setting value. That is, a plurality of options may be adjusted for each course. Each of the plurality of options has a plurality of option values, and any one of the plurality of option values for each option may be stored as the option setting value and be reflected in a corresponding course.

On the other hand, even though the user does not check the option screen 440, the course selection screen 410 may include the option guidance area 413 so that the user may check option setting value information for each option in a currently displayed course.

That is, the course selection screen 410 is provided with the option guidance area 413 in which an option setting value of each of the plurality of options is displayed. Accordingly, the user may conveniently check option setting values of a current course through the option guidance area 413.

However, the option screen 440 may be provided with the option value display area 4401 in which an option setting value of a corresponding option and at least a part of the remaining option values are displayed together with the option setting value. Through the option value display area 4401, the user may conveniently confirm whether option values desired by the user are present on the option screen 440 and may change the option setting value.

Furthermore, a current option setting value in the option value display area 4401 may be displayed differently from the remaining option values. FIG. 12 illustrates the current option set value in the option value display area 4401, displayed in a larger size than the remaining option values and in a different color and brightness from the remaining option values. However, various methods of distinguishably displaying option setting values may be adopted.

In an embodiment of the present disclosure, the user is intuitively and simply informed of an option setting value of each option through the option guidance area 413 even on the course selection screen 410. Furthermore, the option screen 440 displays an option value in addition to the option setting value so that the user may conveniently check a currently desired option setting value.

Meanwhile, in an embodiment of the present disclosure, the option screen 440 may further include an option name display area 4405 together with the option value display area 4401. As described above, according to an embodiment of the present disclosure, the option screen 440 may include a plurality of option screens 440 such as the first option screen 441 and the second option screen. Accordingly, the option name display area 4405 may be provided on the option screen 440 to indicate a type of option currently being changed to the user.

FIG. 12 illustrates an example in which text “rinse” is displayed in order to inform the user of a rinsing recovery option on the option name display area 4405 of the first option screen 441 and text “washing” is displayed in order to notify the user of a washing strength option on the option name display area 4405 of the second option screen.

However, the first option and the second option are not necessarily limited to the rinsing recovery option and the washing strength option. Further, specific text of the option name display area 4405 for indicating the rinsing recovery option and the washing strength option may also be variously determined.

In an embodiment of the present disclosure, the screen output part 8 may display any one of the plurality of option values as an option setting value on the option screen 440. When the option button part is manipulated, another one of the plurality of option values may be displayed as the option setting value.

For example, the user may change an option setting value to another option value by manipulating the movement button part 260 or change the option setting value to another option value by repeatedly manipulating the option button part.

In an embodiment of the present disclosure, the screen output part 8 may sequentially display at least some of the plurality of option values on the option screen 440. When the option button part is manipulated, an option value corresponding to the next order of a current option setting value may be changed to an option setting value and then displayed.

A plurality of option values for each of a plurality of options may be prestored in the controller 60, and at least some of the plurality of option values for a corresponding option may be displayed on the option screen 440.

That is, the number of option values simultaneously displayed in the option value display area 4401 of the option screen 440 may be predetermined. If the number of option values of the corresponding option exceeds the number of option values simultaneously displayed in the option value display area 4401, the option value display area 4401 may display an option value of the previous order and an option value of the next order, based on an option value corresponding to a current option setting value in the option value display area 4401.

In FIG. 12, an option value corresponding to the previous order of an option value stored as an option setting value and an option value corresponding to the next order are displayed together in the option value display area 4401. However, the number of option values simultaneously displayed in the option value display area 4401 may vary as needed.

The user may change a current option value of an option setting value to another option value by manipulating the option button part in a state in which the option screen 440 is output. That is, when an option signal of the option button part is input in a state in which the option screen 440 is output from the screen output part 8, the controller 60 may change and set an option value corresponding to the next order of the option value corresponding to the current option setting value to the option setting value.

The user may set a desired option value among a plurality of option values to an option setting value on the option screen 440 by repeating an input process of the option button part.

Meanwhile, when the option button part is manipulated in a state in which the option screen 440 is output, the screen output part 8 may display the plurality of option values as a moving motion and equally maintain the remaining areas except for the plurality of option values.

That is, the option screen 440 may change only the display of the option value display area 4401 in a state in which there is no change in the remaining area except for the option value display area 4401 manipulated by the option button part. That is, according to an embodiment of the present disclosure, even if the option button part is repeatedly manipulated, only the change of the option value is output without unnecessary screen change, thereby minimizing an unnecessary screen change and effectively providing option value information to the user.

In the option value display area 4401, each option value may be displayed as a moving motion. That is, when the option button part is manipulated, each option value of the option value display area 4401 may be displayed to move like an animation. FIG. 12 illustrates a state in which an option setting value is changed due to input of the input button part in a state in which the option screen 440 is output according to an embodiment of the present disclosure.

Meanwhile, the option screen 440 may include an option setting value display area 4403 in which a current option setting value is displayed and may further include a previous order display area 4402, which is located on one side of the option setting value display area 4403 and displays a previous order option value of the current option setting value, and a next order display area 4404, which is located on the other side of the option setting value display area 4403 and displays a next order option value of the current option setting value.

In addition, when the option button part is manipulated in a state in which the option screen 440 is output, an option value of the option setting value display area 4403 is moved to the previous order display area 4402 and displayed, and an option value of the next order display area 4404 may be moved to the option setting value display area 4403 and displayed.

Specifically, in an embodiment of the present disclosure, the option value display area 4401 may include the option setting value display area 4403, the previous order display area 4402, and the next order display area 411. An option value set as a current option setting value is displayed in the option setting value display area 4403, and an option value corresponding to the previous order of the option value displayed in the option setting value display area 4403 is displayed in the previous order display area 4402. An option value corresponding to the next order of the option value displayed in the option setting value display area 4403 may be displayed in the next order display area 4404.

That is, according to an embodiment of the present disclosure, an option value corresponding to an option setting value is displayed in the option setting value display area 4403 so that the user may easily recognize a current option setting value. In addition, the previous order display area 4402 and the next order display area 4404 are disposed on one side and the other side of the option setting value display area 4403, respectively, so that the user may intuitively recognize the order of option values and easily recognize the change of option setting values according to manipulation of the option button part.

In FIG. 12, the previous order display area 4402, the option setting value display area 4403, and the next order display area 4404, arranged side by side in a vertical direction, according to an embodiment of the present disclosure are illustrated.

In addition, in FIG. 12, a result of changing an option setting value due to input of the option button part in a state in which the option screen 440 is output is illustrated. As described above, when the option button part is manipulated, a screen may be output in which the location of each option value of the option value display area 4401 is changed through a moving motion.

According to an embodiment of the present disclosure, when the option button part is manipulated, an option value, which has been originally located in the next order display area 4404, may be moved to the option setting value display area 4403, and an option value, which has been originally located in the option setting value display area 4403, may be moved to the previous order display area 4402. On the other hand, an option value, which has not been displayed in the option value display area 4401, may be newly displayed in the next order display area 4404.

Meanwhile, the screen output part 8 may be configured such that, when the first movement button part 261 is manipulated in a state in which the option screen 440 is output, the option value of the option setting value display area 4403 is moved to the previous order display area 4402 and displayed, and when the second movement button part 262 is manipulated, the option value of the option setting value display area 4403 is moved to the next order display area 4404 and displayed.

That is, according to an embodiment of the present disclosure, in a state in which the option screen 440 is output, the option setting value may be changed when the option button part is input, when the movement button part 260 is manipulated, or when any one of the option button part and the movement button part 260 is manipulated. The manipulation method in the option screen 440 may be variously determined as needed.

Meanwhile, when no manipulation signal of the option button part is generated during an option setting time preset in the controller 60 in a state in which the option screen 440 is output, the screen output part 8 may return to the course selection screen 410 from the option screen 440.

As described above, the option screen 440 may be output in a pop-up form from the course selection screen 410. When the option screen 440 is terminated, the course selection screen 410 may be output again on the display 84 of the screen output part 8. In this case, an option setting value adjusted through the option screen 440 may be displayed in the option guidance area 413 of the course selection screen 410.

The option setting time for terminating the option screen 440 may be preset in the controller 60. When no manipulation signal of the option button part is generated during the option setting time after the option screen 440 is output from the screen output part 8, the controller 60 may determine that there is no option setting intention of the user.

That is, when the manipulation signal by the user is not generated during the option setting time in a state in which the option screen 440 is output, the controller 60 may control the screen output part 8 to return to the course selection screen 410 from the option screen 440, thereby terminating an option setting process.

Meanwhile, according to an embodiment of the present disclosure, as described above, the option button part may correspond to a part of the option part, and the option part may further include the option display part constituting the option adjuster together with the option button part.

The option display part may be configured to display an option setting value, and the screen output part 8 may display the option setting value together with the option display part on the option screen 440.

That is, according to an embodiment of the present disclosure, the option display part indicates a change in the option setting value to the user through a change in light emitting characteristics of the light emitting part 205 and also visually displays the change in the option setting value through the option screen 440 output from the screen output part 8, thereby effectively improving convenience of use.

FIG. 13 illustrates the option recommendation screen 460 that is converted and output from the course selection screen 410 according to an embodiment of the present disclosure. The option recommendation screen 460 may correspond to a part of the course setting screen 400 output from the screen output part 8 in the course setting process P2.

As described above, the laundry treatment apparatus 1 according to an embodiment of the present disclosure may include the cabinet 10, the drum 30, the manipulation part, the screen output part 8, and the controller 60. The controller 60 may be signally connected to the manipulation part and the screen output part 8. A plurality of courses for treating laundry may be prestored in the controller 60, and option setting values for a plurality of options in each course may be adjusted based on the manipulation signal.

The screen output part 8 is configured to output the course selection screen 410 in which one of the plurality of courses is displayed and selected by the user based on the manipulation signal. The controller 60 may store a preset option combination of option setting values for the plurality of options with respect to a course displayed in the course selection screen 410 and suggest the option combination to the user through the screen output part 8.

As described above, each of the plurality of courses may be configured so as to adjust a plurality of options. For each course, each of the plurality of options may have an initial option setting value. If there is no separate option adjusted by the user, the corresponding course may be performed based on the initial option setting value.

Meanwhile, if there are more option setting values set by the user than a preset cumulative number of times, the controller 60 may store the option setting values set by the user for a plurality of options as the option combination and suggest the option combination to the user when the user selects a course in the future.

In addition, the controller 60 may prestore option setting values that are expected to be recommended or necessary for the user with respect to a plurality of options in performing a course and prestore the option combination of option setting values that are expected to be recommended or necessary for the user with respect to the plurality of options are combined.

That is, the controller 60 may store a collection of option setting values, which is set by the user, more than a cumulative number of times or is recommended for the user, as the option combination and suggest the option combination to the user during a course selection process of the user.

Meanwhile, in an embodiment of the present disclosure, a plurality of option combinations may be stored in the controller 60, and in the plurality of option combinations, at least some option setting values for the plurality of options may be differently set.

That is, in an embodiment of the present disclosure, any one option combination may include respective option setting values for the plural options, and a plurality of different option combinations may be stored in the controller 60. In the plurality of option combinations, option setting values for at least one option may be differently set.

According to an embodiment of the present disclosure, an option combination may be recommended to the user in the course selection process to improve convenience of use. Furthermore, a plurality of option combinations may be provided to the user to select various option combinations.

The method in which the plurality of option combinations is suggested to the user through the option recommendation screen 460 may be the same as or similar to the method in which a plurality of courses is provided to the user in the course selection screen 410.

For example, any one option combination of the plurality of option combinations may be selectively displayed on the option recommendation screen 460, and the user may manipulate the movement button part 260 to sequentially display the plurality of option combinations on the screen.

A method of suggesting an option combination according to an embodiment of the present disclosure will now be described as follows with reference to FIG. 13.

In a state in which the course selection screen 410 is output from the screen output part 8, the multi-function button part 91 may have an option recommendation function. That is, when a manipulation signal of the multi-function button part 91 is generated while the course selection screen 410 is output, the controller 60 may control the screen output part 8 to output the option recommendation screen 460 for recommending an option combination to the user.

The course selection screen 410 may include the function display area 405 for displaying the functions of the multi-function button part 91, and text indicating the option recommendation function in which an option combination is recommended when the multi-function button part 91 is manipulated may be displayed in the function display area 405.

In FIG. 13, the alias of the option recommendation function called “master card” is displayed in the function display area 405, and text representing the option recommendation function may be determined in various ways according to need.

When the multi-function button part 91 is manipulated in the course selection screen 410, a screen output in the display 84 of the screen output part 8 may be switched from the course selection screen 410 to the option recommendation screen 460.

The option recommendation screen 460 may include an option recommendation course display area 461, an option combination area 462, and the function display area 405.

Text indicating a course displayed on the course selection screen 410 may be displayed in the option recommendation course display area 461. For example, the name of the course may be displayed in the option recommendation course display area 461. The user may conveniently check a target course of a currently recommended option combination through the option recommendation course display area 461.

A plurality of option combinations may be selectively displayed in the option combination region 462. A method of displaying the plurality of option combinations in the option combination area 462 is similar to the method of displaying a plurality of courses on the course selection screen 410.

That is, any one of the plurality of option combinations is displayed in the option combination area 462, and the user may manipulate the movement button part 260 to change the option combination displayed in the option combination area 462 to another option combination.

In FIG. 13, a second option combination 4602 is displayed in the option combination area 462 according to manipulation of the manipulation part by the user in a state in which a first option combination 4601 is displayed in the option combination area 462 of the option recommendation screen 460.

As will be described later, the controller 60 may preset an option combination group applicable to each course among a plurality of option combinations, and only an option combination corresponding to an option combination group applicable to a course displayed in the option recommendation course display area 461 may be displayed in the option combination area 462 of the option recommendation screen 460.

Various information about a currently displayed option combination may be displayed in the option combination region 462. For example, the name of an option combination and option setting values of respective options included in the option combination may be displayed in the option combination region 462.

The option recommendation screen 460 may include the function display area 405 for displaying the functions of the multi-function button part 91 as on the course selection screen 410. In the option recommendation screen 460, the multi-function button part 91 may have an end function for terminating the option recommendation screen 460, and text indicating the end function of the multi-function button part 91 may be displayed in the function display area 405.

Although text “close” is displayed in the function display area 405 in FIG. 13, this is purely an example for explaining the present disclosure, and text indicating the end function of the multi-function button part 91 may vary as needed.

In an embodiment of the present disclosure, a plurality of option combinations is stored in the controller 60, and option combinations applicable to each of the plurality of courses may be preset in the controller 60. The controller 60 may control the screen output part 8 to display option combinations applicable to the course displayed on the course selection screen 410 among the plurality of option combinations.

As described above, in an embodiment of the present disclosure, the option part may include the plurality of option adjusters corresponding to a plurality of options and include the additional option button part for additional options other than options adjusted by the option adjusters. Furthermore, the plurality of option adjusters may be set in the controller 60 so as not to allow change with respect to each course.

That is, in an embodiment of the present disclosure, there may be a case in which a plurality of option combinations is not applied to some of the plurality of courses according to option characteristics of the option combinations. Accordingly, the controller 60 may preset applicability of a plurality of option combinations to each course.

Therefore, in an embodiment of the present disclosure, the controller 60 may store a plurality of option combinations to provide convenience to the user through various option setting values. However, since certain options may not be changed or applicable due to characteristics of the courses, applicability of the option combinations to each course may be preset in the controller 60, so that convenience of use may be improved by recommending an optimal option combination for each course to the user.

In an embodiment of the present disclosure, when any one of a plurality of courses is displayed in the screen output part 8, the controller 60 may suggest option combinations applicable to the any one course to the user through the screen output part 8.

In an embodiment of the present disclosure, the controller 60 may not provide the option combinations with respect to some of the plurality of courses. In other words, in an embodiment of the present disclosure, some of the plurality of courses may be set so that the option combinations may not be applied. In other words, some of the plurality of courses may be provided such that options are incapable of being changed.

For example, in an embodiment of the present disclosure, the plurality of courses may include a tub sterilization course for automatically cleaning the inside of the drum 30 using steam, etc. Since the tub sterilization course is not a course in which clothes are directly treated, the number of times of rinsing, washing intensity, water temperature, and applicability of steam may be set so as not to be arbitrarily adjusted.

In addition to the above tub sterilization course, there may be courses that are incapable of being changed for a plurality of options included in an option combination for various reasons. Accordingly, in an embodiment of the present disclosure, the controller 60 may be set not to suggest an option combination with respect to a part of a plurality of courses.

In an embodiment of the present disclosure, the plurality of option combinations may include a most frequent combination. The controller 60 may store option setting values identically set by the user in a laundry treatment process of a preset reference number of times or more as the most frequent combination.

As described above, if an option setting value set by the user is applied more than the preset reference number of times in the laundry treatment process P3, the controller 60 may store respective option setting values for the plurality of options as the most frequent combination corresponding to one of the plurality of option combinations and recommend the stored most frequent combination to the user.

In FIG. 13, a combination recommendation screen in which a first combination option is displayed is illustrated, and the first combination option may correspond to the most frequent combination.

In an embodiment of the present disclosure, when there are multiple option setting values that are identically set in the laundry treatment process above the reference number of times, the controller 60 may store an option setting value with the highest frequency of use as the most frequent combination.

As the period of use of the laundry treatment apparatus 1 increases, option setting values set by the user more than the reference number of times may increase. When there is a plurality of option setting values set by the user more than the reference number of times, the controller 60 may store an option setting value having the highest frequency of use among a plurality of option setting values used the reference number of times or more as the most frequent combination and recommend the stored most frequent combination to the user.

In an embodiment of the present disclosure, as described above, the screen output part 8 may be switched to the option recommendation screen 460 that displays the option combination on the course selection screen 410 based on the manipulation signal.

The option recommendation screen 460 may be provided in a pop-up form on the course selection screen 410, such as the option screen 440 described above, and the entirety of the course selection screen 410 may be switched to the option recommendation screen 460.

As described above, the screen output part 8 may selectively display any one of the plurality of option combinations on the option recommendation screen 460, and a currently displayed option combination may be changed based on the manipulation signal of the manipulation part.

The manipulation part may include the multi-function button part 91 that is provided on the screen output part 8 and has a function varying according to a screen output from the screen output part 8. When the manipulation signal of the multi-function button part 91 is generated in a state in which the course selection screen 410 is output, the screen output part 8 may be switched to the option recommendation screen 460.

Furthermore, the course selection screen 410 includes the function display area 405 that displays the functions of the multi-function button part 91, and a function of entering the option recommendation screen 460 may be displayed in the function display area 405 of the course selection screen 410.

In addition, when the manipulation signal of the multi-function button part 91 is generated in a state in which the option recommendation screen 460 is output, the screen output part 8 may return to the course selection screen 410 from the option recommendation screen 460. That is, as described above, the multi-function button part 91 may have an option recommendation end function in a state in which the option recommendation screen 460 is output. Accordingly, an end function of the option recommendation screen 460 may be displayed in the function display area 405 of the option recommendation screen 460.

In an embodiment of the present disclosure, when the execution button part 282 for instructing execution of the laundry treatment process P3 is manipulated in a state in which any one option combination is displayed on the option recommendation screen 460, the controller 60 may cause the laundry treatment apparatus 1 to perform the laundry treatment process P3 by applying an option combination displayed in the option combination area 462 to a course displayed in the option recommendation course display area 461 of the option recommendation screen 460.

In an embodiment of the present disclosure, option setting values of an option combination displayed on the option recommendation screen 460 may be simultaneously displayed on the option recommendation screen 460 and the option display part.

If the option combination displayed on the option recommendation screen 460 is changed according to manipulation of the movement button part 260 etc., the option display part may also be configured to change and display option setting value information in response to a change in the option combination.

Hereinafter, an option combination recommendation function according to an embodiment of the present disclosure will be described based on manipulation of the manipulation part by the user as follows.

In an embodiment of the present disclosure, the manipulation part may be provided in the cabinet 10 and configured to be manipulated by the user to generate a manipulation signal. The screen output part 8 may be provided in the cabinet 10 to output a screen for providing information to the user.

The controller 60 may be signally connected to the manipulation part and the screen output part 8, and a plurality of courses for treating laundry may be prestored in the controller 60. Option setting values for a plurality of options in each course may be adjusted based on the manipulation signal.

The screen output part 8 is configured to output the course selection screen 410 that displays any one of the plurality of courses to be selected by the user based on the manipulation signal. An option combination in which respective option setting values for the plural options are preset with respect to a course displayed on the course selection screen 410 is stored in the controller 60. The screen output part 8 may switch from the course selection screen 410 to the option recommendation screen 460 on which the option combination is displayed based on the manipulation signal.

The manipulation part may include the multi-function button part 91. The multi-function button part 91 may be provided on the screen output part 8 and may vary a function thereof according to a screen output from the screen output part 8. If the manipulation signal of the multi-function button part 91 is generated in a state in which the course selection screen 410 is output, the screen output part 8 may be switched to the option recommendation screen 460.

The course selection screen 410 includes the function display area 405 that displays the functions of the multi-function button part 91, a function of entering the option recommendation screen 460 may be displayed in the function display area 405 of the course selection screen 410.

The screen output part 8 may selectively display any one of the plurality of courses on the course selection screen 410. If the manipulation signal of the multi-function button part 91 is generated, the screen output part 8 may be configured to display an option combination of the course displayed on the course selection screen 410. That is, the option combination applicable to the corresponding course may be displayed on the option recommendation screen 460.

The execution button part 282 may be provided in the cabinet 10 and may generate an execution signal of the course displayed on the course selection screen 410. That is, the controller 60 may determine the manipulation signal of the execution button part 282 as the execution signal.

When the execution signal is generated, the controller 60 may be configured to apply the option combination displayed on the option recommendation screen 460 to the course displayed on the course selection screen 410.

When the manipulation signal of the multi-function button part 91 is generated in which the option recommendation screen 460 is output, the screen output part 8 may be configured to return to the course selection screen 410 from the option recommendation screen 460.

That is, when the manipulation signal of the multi-function button part 91 is generated in a state in which the option recommendation screen 460 is output, the controller 60 may control the screen output part 8 to cause the screen of the display 84 to return from the option recommendation screen 460 to the course selection screen 410.

Meanwhile, when the option recommendation screen 460 returns to the course selection screen 410 through the multi-function button part 91, the controller 60 may control the screen output part 8 to ignore the option combination recommended on the option recommendation screen 460 and output the course selection screen 410 reflecting option setting values before entering the option recommendation screen 460.

That is, when the manipulation signal of the multi-function button part 91 is input in a state in which the option recommendation screen 460 is output, the controller 60 may restore option setting values of respective options of the course displayed on the course selection screen 410 to initial values.

In an embodiment of the present disclosure, when the option part is manipulated in a state in which the option recommendation screen 460 is output, the screen output part 8 may return to the course selection screen 410 from the option recommendation screen 460.

That is, the controller 60 may control the screen output part 8 to output the course selection screen again by accepting the manipulation signal of the option button part or the additional option button part of the option part in the option recommendation screen 460 like the manipulation signal of the multi-function button part 91.

As described above, the option part may further include the plurality of option display parts that display respective option setting values of the plural options. An option combination value of an option combination displayed in the option recommendation screen 460 may be simultaneously displayed in the option recommendation screen 460 and the option display parts.

The screen output part 8 may selectively display any one of applicable option combinations on the option recommendation screen 460, and the option combination displayed on the option recommendation screen 460 may be changed based on the manipulation signal.

The manipulation part may include the above-described movement button part 260. The screen output part 8 may be configured such that, when the movement button part 260 is manipulated in a state in which the course selection screen 410 is output, a course displayed on the course selection screen 410 is changed and, when the movement button part 260 is manipulated in a state in which the option recommendation screen 460 is output, the option combination displayed on the option recommendation screen 460 is changed.

Meanwhile, the laundry treatment apparatus 1 according to an embodiment of the present disclosure may include the cabinet 10, the drum 30, the manipulation part, the screen output part 8, and the controller 60. The screen output part 8 is configured to output the course selection screen 410 that displays any one of the plurality of courses to be selected by the user based on the manipulation signal. An option combination in which respective option setting values for the plural options are preset with respect to the course displayed on the course selection screen 410 is stored in the controller 60. When the multi-function button part 91 is manipulated, the screen output part 8 may switch from the course selection screen 410 to the option recommendation screen 460 on which the option combination is displayed.

FIG. 14 illustrates a setting screen 420 out of the course setting screen 400 output from the screen output part 8 in an embodiment of the present disclosure.

As described above, the laundry treatment apparatus 1 according to an embodiment of the present disclosure includes the cabinet 10, the drum 30, the manipulation part, the screen output part 8, and the controller 60. The drum 30 is rotatably provided inside the cabinet 10 to accommodate laundry therein.

The manipulation part may be provided in the cabinet 10 and may be manipulated by the user to generate a manipulation signal. The screen output part 8 may be provided in the cabinet 10 and may output a screen for providing information to the user. The controller 60 may be signally connected to the manipulation part and the screen output part 8 and may store a plurality of courses for treating laundry accommodated in the drum 30.

In an embodiment of the present disclosure, the controller 60 may designate and store at least some of the plurality of courses as a display group, and the screen output part 8 may be configured to output the course selection screen 410 on which courses designated as the display group are displayed. The controller 60 may be configured to perform a course selected from the course selection screen 410, and whether each of the plurality of courses is designated as the display group may be configured to be changeable by the user through the manipulation part.

Specifically, various courses for treating laundry, such as a normal wash course, a normal dry course, and a spin-dry course, may be prestored in the controller 60. Meanwhile, the screen output part 8 may output the course selection screen 100 that displays the plurality of courses in the course setting process P2 according to an embodiment of the present disclosure and allows the user to select any one of the plurality of courses based on a manipulation signal of the manipulation part.

That is, the controller 60 may control the screen output part 8 to display the plurality of courses in the course setting process P2 after the booting process P1 and to output the course selection screen 410 selectable by the user.

In order to efficiently display the plurality of courses in the limited area of the display 84, the screen output part 8 may be configured to selectively display only one of the plurality of courses on the course selection screen 410.

In addition, the course displayed on the course selection screen 410 may be changed based on the manipulation signal of the manipulation part. For example, when the user manipulates the above-described movement button part 260 in a state in which the course selection screen 410 is output, the plurality of courses may be sequentially displayed one by one.

Here, the controller 60 may store a plurality of courses so as to satisfy various needs of the user. Displaying all of the plurality of courses on the course selection screen 410 may include an unnecessary course according to the user and may cause inconvenience of use when the number of courses is too large.

Accordingly, in an embodiment of the present disclosure, the user may designate and use the course displayed on the course selection screen 410 with respect to the plurality of courses stored in the controller 60, so that the demand for each user may be effectively satisfied and convenience of use may be effectively improved.

In an embodiment of the present disclosure, a display group to be displayed on the course selection screen 410 among the plurality of prestored courses may be set in the controller 60. That is, only the courses designated as the display group among the plurality of courses may be displayed on the course selection screen 410, and the user may confirm and select only the courses designated as the display group from the course selection screen 410, so that the convenience of use may be improved.

In addition, whether to designate each of the plurality of courses stored in the controller 60 as the display group may be directly selected by the user. For example, whether to designate each of the plurality of courses as the display group may be changed by and stored in the controller 60 based on the manipulation signal of the manipulation part by the user.

Accordingly, the user may select courses required thereby among the various courses stored in the controller 60 and designate the selected courses as the display group, and the display group reflecting the request of the user may be displayed on the course selection screen 410, so that the use environment of the user may be effectively improved.

More specifically, as described above, the course selection screen 410 may include the order display area 411, the course name area, and the option guidance area 413. Only the courses designated as the above-described display group may be displayed in the course name area.

Only one of the courses designated as the display group may be displayed in the course name area. Option setting values for the course displayed in the course name area may be displayed in the option guidance area 413. The user may manipulate the above-described movement button part 260 to change the course displayed in the course name area and the option guidance area 413 to a course of the next order or the previous order to determine whether to select the course of the next order or the previous order.

The order and the number of courses displayed in the order display area 411 may be displayed depending on a setting state of the display group. That is, the number of courses displayed in the order display area 411 may correspond to the number of courses designated as the display group, and order information of a current course displayed in the order display area 411 may correspond to order information in the display group.

In an embodiment of the present disclosure, the remaining courses except for the courses designated as the display group among the plurality of courses may be set not to be displayed on the course selection screen 410.

That is, the controller 60 may control the screen output part 8 to display only the courses designated as the display group on the course selection screen 410. Accordingly, the user may select any one course for laundry treatment only with respect to the courses corresponding to the display group reflecting the intention of the user on the course selection screen 410 of the screen output part 8, thereby improving the efficiency of use.

Meanwhile, only one of the courses designated as the display group may be selectively displayed on the course selection screen 410, and the course displayed on the course selection screen 410 may be changed to another course based on the manipulation signal.

As described above, in order to effectively provide information in the limited area of the display 84, one of the courses set as the display group may be selectively displayed on the course selection screen 410.

In a state on which any one course is displayed on the course selection screen 410, the user may manipulate the manipulation part, for example, the movement button part 260, to change the course displayed on the course selection screen 410.

In an embodiment of the present disclosure, a method in which the user selects a course through the course selection screen 410 and commands the controller 60 to perform the course is as follows.

The screen output part 8 may output the course selection screen 410 under the control of the controller 60, and only one of the courses designated as the display group may be displayed on the course selection screen 410.

The user may determine whether to cause the laundry treatment apparatus 1 to perform a currently displayed course by checking the course name area and the option guidance area 413. If the user generates an execution signal, which is one of manipulation signals, by manipulating the above-described execution button part 282 in a state in which the course selection screen 410 is output, the controller 60 may recognize that the user has selected application of current option setting values to the course displayed on the course selection screen 410 and cause the laundry treatment apparatus 1 to perform the laundry treatment process P3 based on the corresponding course.

When the user requests a course other than the course currently displayed on the course selection screen 410, the user may manipulate the movement button part 260 to change the course displayed on the course selection screen 410 to another course.

That is, in a state in which the course selection screen 410 is output from the screen output part 8, the user may manipulate the movement button part 260 to display any one of various courses designated as the display group on the course selection screen 410. The user may operate the execution button part 282 in a state in which the course desired to be performed is displayed on the course selection screen 410, so that the course desired by the user is performed.

In a state in which the course selection screen 410 is output, when the first movement button part 261 is manipulated, the screen output part 8 may display a course corresponding to the next order of the currently displayed course, and when the second movement button part 262 is manipulated, the screen output part 8 may display a course corresponding to the previous order of the currently displayed course.

The order information of the courses may be stored in the controller 60, and the controller 60 may control the screen output part 8 to display the course corresponding to the next order or previous order of the course displayed on the course selection screen 410 on the course selection screen 410 based on the manipulation signal of the movement button part 260.

In an embodiment of the present disclosure, the screen output part 8 may be configured to output a course editing screen on which a course list including the plurality of courses is displayed based on the manipulation signal.

The user may manipulate the manipulation part to output the course editing screen. The controller 60 may control the screen output part 8 to output the course editing screen based on the manipulation signal of the manipulation part.

For example, the user may manipulate a setting button part out of the additional option button part of the above-described option part to output the setting screen 420 from the screen output part 8. The setting list 421 including a course editing item 4212 may be displayed on the setting screen 420. The user may select the course editing item 4212 using the movement button part 260 and the multi-function button part 91. When the course editing item 4212 is selected, the controller 60 may control the screen output part 8 to output the course editing screen.

All courses stored in the controller 60 may be listed and displayed in the course list. That is, the user may identify the plurality of courses stored in the controller 60 as a whole through the course list of the course editing screen, designate courses that the user intends to use in the course list as a display group, and release of designation of courses that the user does not intend to use from the display group, thereby setting a desired display group.

Meanwhile, the screen output part 8 may be switched from the course selection screen 410 to the course editing screen based on the manipulation signal. In an embodiment of the present disclosure, if the course editing screen needs to be output in order to efficiently utilize the limited output area of the screen output part 8, i.e., the area of the display 84, the course editing screen may be output instead of the course selection screen 410.

In an embodiment of the present disclosure, various screens may be efficiently output even in the limited area of the display 84 through switching output of the screens.

In an embodiment of the present disclosure, the manipulation part may include the setting button part. When a manipulation signal of the setting button part is generated in a state in which the course selection screen 410 is output, the screen output part 8 may be switched to the setting screen 420 on which a plurality of setting items is displayed, and when the course editing item 4212 is selected from among the plurality of setting items according to the manipulation signal in a state in which the setting screen 420 is output, the screen output part 8 may be switched to the course editing screen.

When the setting button part is manipulated by the user in a state in which the course selection screen 410 is output from the screen output part 8, the controller 60 may control the screen output part 8 to output the setting screen 420 instead of the course selection screen 410.

The setting list 421 including setting items related to setting for the overall use environment of the laundry treatment apparatus 1 as well as setting of the currently displayed course may be displayed on the setting screen 420.

FIG. 14 conceptually illustrates switching from the course selection screen 410 to the setting screen 420 according to a setting signal of the setting button part. Meanwhile, the setting list 421 may include a plurality of setting items such as language setting and initialization setting, and the screen output part 8 may be provided to display a predetermined number of setting items among the plurality of setting items on the setting screen 420 in order to efficiently express the plurality of setting items in the limited area of the display 84.

In FIG. 14, an example of the setting list 421 stored in the controller 60 is illustrated, and an example in which a part of the setting list 421 is displayed on the setting screen 420 is illustrated. However, the setting screen 420 and the setting list 421 illustrated in FIG. 14 are only examples for convenience of description, and the number of setting items simultaneously displayed in the setting list 421 or the content of the entirety of the setting items of the setting list 421 may be variously changed as needed.

In a state in which a part of the plurality of setting items is displayed on the setting screen 420, the user may change the setting items displayed on the setting screen 420 through manipulation of the manipulation part such as the movement button part 260.

That is, when the manipulation signal of the movement button part 260 is generated in a state in which the setting screen 420 is output, the controller 60 may control the screen output part 8 to change and display the currently displayed setting items according to the order of the setting list 421.

FIG. 14 illustrates the setting screen 420 on which the course editing item 4212 among the setting items is displayed in the screen output part 8. The name indicating the course editing item 4212 may be variously determined.

In an embodiment of the present disclosure, when a plurality of items is displayed on the screen, the screen output part 8 may be configured to indicate any one item as a selection target object. In FIG. 14, the course editing item 4212 among the plurality of setting items has a different color or brightness from the remaining setting items and is indicated as the selection target object.

In an embodiment of the present disclosure, a selection target indication having a different color or illuminance from the remaining items is applied to one of the plurality of items, and the item to which the selection target indication is applied corresponds to a current selection target object. When the user manipulates the manipulation part such as the multi-function button part 91 or the execution button part 282, the controller 60 may recognize that the selection target object to which the selection target indication is applied is selected and cause the laundry treatment apparatus 1 to perform a subsequent procedure.

In a state in which a plurality of items is displayed in the screen output part 8, the user may manipulate the movement button part 260 to change the selection target object. For example, when the user manipulates the first movement button part 261 in a state in which the setting screen 420 of FIG. 14 is output, the selection target indication may be moved to an item located under the course editing item 4212, and when the user manipulates the second movement button part 262, the selection target indication may be moved to an item located above the course editing item 4212.

On the other hand, when the user manipulates the first movement button part 260 in a state in which the selection target indication is applied to the lowermost item among the items displayed in the screen output part 8, the screen output part 8 may be configured to display an item of the next order on the screen although the item is not displayed on the current screen and remove the uppermost item among the items displayed on the current screen from the screen.

Meanwhile, in a state in which the setting screen 420 is output from the screen output part 8, the multi-function button part 91 may be activated to have a selection function. That is, the controller 60 may be configured to recognize the manipulation signal of the multi-function button part 91 as a selection signal in a state in which the setting screen 420 is output and cause the laundry treatment apparatus 1 to perform a subsequent procedure according to selection of a current selection target object.

That is, in an embodiment of the present disclosure, the course selection screen 410 may be output from the screen output part 8 in the course setting process P2, and when the user manipulates the setting button part in a state in which the course selection screen 410 is output, the controller 60 may control the screen output part 8 to output the setting screen 420 instead of the course selection screen 410 in the screen output part 8. When the user manipulates the multi-function button part 91 in a state in which the selection target indication is located on the course editing item 4212 due to manipulation of the movement button part 260 in a state in which the setting screen 420 is output, the controller 60 may determine the manipulation signal of the multi-function button part 91 as a selection signal and control the screen output part 8 to output the course editing screen instead of the setting screen 420 in the screen output part 8 according to selection of the course editing item 4212.

In an embodiment of the present disclosure, various information may be effectively transmitted to the user by selectively displaying the course selection screen 410, the setting screen 420, and the course editing screen in one restricted area of the display 84. In addition, since some of the plurality of items are displayed on a screen, and the user may change the displayed item, the plurality of items is efficiently displayed. Furthermore, since the multi-function button part 91 is configured to have various functions as needed, the user may conveniently manipulate the screens or select the items without additionally manipulating the manipulation part.

Referring to FIG. 14, in an embodiment of the present disclosure, the plurality of setting items may include a course alignment item 4211. When the course alignment item 4211 is selected on the setting screen 420, the controller 60 may align and store a display order in which courses of the display group are displayed on the course selection screen 410 according to frequency of use.

In FIG. 14, the screen output part 8 in which the setting list 421 including the course editing item 4212 and a course setting item is displayed according to an embodiment of the present disclosure is illustrated. When the user manipulates the multi-function button part 91 in a state in which the user manipulates the movement button part 260 to locate the selection target indication on the course alignment item 4211, the controller 60 may perform a course alignment process.

In the course alignment process, the controller 60 may set the display order of the courses of the display group according to the frequency of use of a course recently used in the laundry treatment process P3. For example, the controller 60 may set the display order from the most frequently used course to the least frequently used course in the predetermined number of times of the laundry treatment processes P3.

According to an embodiment of the present disclosure, since the course alignment item 4211 is provided to the user, the courses of the display group having the display order that reflects the frequency of use used by the user may be provided to the user, thereby improving convenience of use.

In an embodiment of the present disclosure, whether the display group is designated for each of the plurality of courses may be displayed in the course list and may be changed based on the manipulation signal.

Specifically, a plurality of course items stored in the controller 60 may be displayed in the course list, and whether each course item is designated as the display group may be indicated. A check mark may appear in a display box of each of the course items designated as the display group among the plurality of course items, and a check mark may be removed from a display box of each of course items not designated as the display group.

In an embodiment of the present disclosure, when the manipulation signal of the multi-function button part 91 is transmitted in the course editing screen, the controller 60 may designate a currently selected course not designated as the display group or release a currently selected course designated as the display group.

That is, the multi-function button part 91 may have a function of changing the designation as the display group in the course editing screen. When the manipulation signal of the multi-function button part 91 is generated for any one course item, the controller may designate a course item not designated as the display group or release a course item designated as the display group.

In addition, in a state in which a third course is released from designation as the display group, if the manipulation signal of the multi-function button part 91 is generated with respect to the third course, the controller 60 may designate and store the third course as the display group.

In an embodiment of the present disclosure, the multi-function button part 91 may have a setting item selection function in the setting screen 420 and may have a display group designation changing function in the course editing screen. That is, in an embodiment of the present disclosure, since the multi-function button part 91 has different functions according to the screens of the screen output part 8, various functions may be input even if different button parts are not provided for respective screens, and thus the multi-function button part 91 may be advantageous in design. Since the user may use various functions using only one multi-function button part 91, the convenience of use may be improved.

Meanwhile, the screen output part 8 may include the function display area 405 for displaying current function information of the multi-function button part 91 in a currently output screen. In addition, since the multi-function button part 91 may have different functions according to the currently output screen, the content displayed in the function display area 405 may be changed according to the screen.

Furthermore, when the multi-function button part 91 is deactivated so as not to perform functions, the function display area 405 may be omitted from the screen output from the screen output part 8.

For example, in an embodiment of the present disclosure, the multi-function button part 91 has a selection function of each setting item in the setting screen 420, and the setting screen 420 may include the function display area 405 in which the selection function of the multi-function button part 91 is displayed.

In FIG. 14, according to an embodiment of the present disclosure, the function display area 405 of the setting screen 420 displays the selection function of the multi-function button part 91 under the name of “selection”, but this may be variously determined as needed.

In an embodiment of the present disclosure, the multi-function button part 91 may have the display group designation changing function for each course item in the course editing screen. Specifically, the multi-function button part 91 may have a display group release function for course items designated as the display group and have a display group designation function for course items for which designation as the display group has been released.

Accordingly, the functions of the multi-function button part 91 may be changed according to a current selection target object, and the display group designation function or the display group designation release function of the multi-function button part 91 may be displayed in the function display area 405 of the course editing screen.

That is, in an embodiment of the present disclosure, the function display area 405 of the setting screen 420 and the function display area 405 of the course editing screen may be differently displayed. Further, the function display areas 405 may be differently displayed according to the selection target object even on the course editing screen.

In an embodiment of the present disclosure, the multi-function button part 91 may have different functions for respective screens and have different functions according to the selection target object on the same screen, thereby enabling the user to advantageously input various commands using one button.

Furthermore, since the function display area 405 for displaying the functions of the multi-function button part 91 is provided on a screen displayed in the screen output part 8, the user may conveniently check and use the functions of the multi-function button part 91.

Meanwhile, in an embodiment of the present disclosure, the controller 60 may be configured to exchange information with the communication terminal 70 portable by the user and synchronize the course list with a terminal course list stored in the communication terminal 70.

As described above, the laundry treatment apparatus 1 according to an embodiment of the present disclosure may be configured to exchange information through the communication terminal 70, which may be carried by the user, and a server, and an application for controlling the operation of the laundry treatment apparatus 1 or checking information may be installed in the communication terminal 70.

The user may edit the course list through the application of the communication terminal 70, and a result of editing the course list in the communication terminal 70 may be transmitted to the controller 60, so that the course list prestored in the controller 60 may be synchronized with the course list edited by the communication terminal 70.

In addition, the course list edited through the course editing screen of the screen output part 8 may be transmitted to the communication terminal 70 so that the user may conveniently check and edit a current course list through the communication terminal 70.

In an embodiment of the present disclosure, the plurality of courses includes fixed courses for which display group designation release is not possible, and the course list may separately display the fixed courses and the remaining courses.

Some of the plurality of courses may be stored in the controller 60 as fixed courses for which display group designation release is not possible. The fixed courses may correspond to basic courses or may be determined in other strategic aspects in use of the laundry treatment apparatus 1.

In an embodiment of the present disclosure, the user may directly edit courses displayed on the course selection screen 410 of the screen output part 8. However, when the user releases designation of the basic courses from the display group through a simple mistake, etc., the user may experience confusion because the basic courses are not displayed on the course selection screen 410.

That is, according to an embodiment of the present disclosure, among the plurality of courses stored in the controller 60, courses that are basic and potentially essential for use may be stored as the fixed courses that prevent the user from arbitrarily releasing designation as the display group, so that stability of use may be effectively secured.

Meanwhile, the fixed courses may be displayed to be distinguished from other courses on the course editing screen of the screen output part 8. For example, the fixed courses may be displayed to have lower brightness unlike the remaining course items.

However, a method of displaying the fixed courses is purely an example for explaining an embodiment of the present disclosure, and the method of displaying the fixed courses may be variously determined as needed.

In an embodiment of the present disclosure, a display order of courses of the display group according to an order in which the courses are designated as the display group may be stored in the controller 60, and a currently displayed course may be sequentially changed on the course selection screen 410 of the screen output part 8 according to the display order based on the manipulation signal of the manipulation part.

That is, the controller 60 may set the display order of the courses of the display group according to the order in which the courses are designated as the display group by the user. For example, a course designated as the most recent display group by the user may be determined as the earliest order or last order by the controller 60.

As described above, the screen output part 8 may sequentially display the courses of the display group on the course selection screen 410 one by one and sequentially display the courses of the display group one by one according to the display order set by the controller 60.

A course designated by the user as the recent display group through the course editing screen may correspond to a course that the user recently intended to use. Therefore, according to an embodiment of the present disclosure, the courses may be displayed on the screen in order of displaying the display group according to the order designated by the user on the course selection screen 410, thereby improving the convenience of the user.

Meanwhile, the fixed courses have an independent display order with respect to the courses designated as the display group, and the display order of the remaining courses except for the fixed courses among the courses of the display group may be determined by avoiding the display order of the fixed courses.

The fixed courses may correspond to general-purpose or commonly used courses regardless of the intention of the user. Accordingly, the fixed courses may be differentiated from the remaining courses in the display order, such as being displayed first or last as compared to the courses of the display group selected by the user.

For example, a normal wash course corresponding to a general wash course may correspond to a typical course in a washing process, and the normal wash course may be designated as the fixed course and may have a first display order throughout the display group regardless of the display order of the remaining courses.

Meanwhile, a tub sterilization course, which is strategically recommended to the user for hygiene reasons in the laundry treatment process P3, is not used in the general laundry treatment process P3, but may be designated as the fixed course to be recommended to the user. However, the tub sterilization course may have the last display order considering the frequency of use.

As described above, according to an embodiment of the present disclosure, the fixed courses may be set for which designation of the display group is incapable of being changed for various reasons, and the display order for the fixed courses is strategically determined unlike the remaining courses, thereby effectively improving convenience of use.

Although the present disclosure has been illustrated and described in connection with specific embodiments, it would be obvious to a person skilled in the art that the present disclosure may be variously modified and changed without departing from the technical spirit of the present disclosure provided by the claims below.

1. A laundry treatment apparatus, comprising:
a cabinet;
a drum rotatably provided inside the cabinet and accommodating clothes therein;
a screen output part provided in the cabinet and configured to output a screen on which a plurality of objects selectable by a user is displayed;
a movement button part provided in the cabinet and manipulated by the user to change a selection target object to be scheduled for selection among the plurality of objects; and
a multi-function button part provided in the screen output part and configured to vary a function according to a screen output from the screen output part.

2. The laundry treatment apparatus of claim 1, wherein the movement button part comprises:
a first movement button part configured to change the selection target object on the screen output from the screen output part to an object of a next order among the plurality of objects; and
a second movement button part configured to change the selection target object on the screen output from the screen output part to an object of a previous order among the plurality of objects.

3. The laundry treatment apparatus of claim 2, wherein, based on a width direction of the cabinet, the first movement button part is located on one side of the screen output part, and the second movement button part is located on the other side of the screen output part.

4. The laundry treatment apparatus of claim 3, wherein the first movement button part and the second movement button part are displayed in a form of lines bent towards opposite directions on the cabinet.

5. The laundry treatment apparatus of claim 2, wherein the screen output part includes a border line extending along a border of the screen output part, and
wherein the movement button part is located outside the border line.

6. The laundry treatment apparatus of claim 1, wherein the movement button part is configured to emit light.

7. The laundry treatment apparatus of claim 1, wherein the multi-function button part is configured to emit light in a state in which the function is activated and the multi-function button part is manipulable by the user.

8. The laundry treatment apparatus of claim 1, wherein the screen output part comprises:
a display on which the screen is output; and
a screen circumference part surrounding and fixing the display,
wherein the multi-function button part is provided in the screen circumference part.

9. The laundry treatment apparatus of claim 8, wherein a clothing opening communicating with an inside of the drum and the screen output part are provided on an upper surface of the cabinet, and
wherein the screen output part is disposed in front of the clothing opening, and
wherein the multi-function button part is positioned in front of the display in the screen circumference part.

10. The laundry treatment apparatus of claim 8, wherein the display is provided in a rectangular shape, and
wherein the screen circumference part is provided in a circular shape, and the display is fixed to an inside of the screen circumference part.

11. The laundry treatment apparatus of claim 1, wherein the screen output part is configured to output a screen including a function display area for displaying a current function of the multi-function button part.

12. The laundry treatment apparatus of claim 1, further comprising a general option part positioned on one side of the screen output part based on a width direction of the cabinet and manipulated by the user to adjust an option of a course for treating laundry.

13. The laundry treatment apparatus of claim 12, wherein the general option part comprises:
a first option adjuster configured to adjust a first option of the course; and
a second option adjuster configured to adjust a second option of the course,
wherein the first option adjuster and the second option adjuster are aligned in the width direction.

14. The laundry treatment apparatus of claim 12, wherein the general option part comprises:
an option display part in which an option setting value of the option is displayed; and
an option button part through which the option setting value of the option is adjusted.

15. The laundry treatment apparatus of claim 14, wherein the option button part is configured to display a name of a related option.

16. The laundry treatment apparatus of claim 14, wherein the option display part includes a plurality of light emitting parts aligned in parallel in one direction, and
wherein the plurality of light emitting parts is related to a plurality of option values for the option, respectively, and
wherein the option display part provides information about the option setting value to the user by causing a light emitting part related to the option setting value among the plurality of option values to emit light among the plurality of light emitting parts.

17. The laundry treatment apparatus of claim 14, further comprising
a controller configured to control rotation of the drum and to perform the course,
wherein a plurality of courses is stored in the controller, an option group settable by the user with respect to each of the plurality of courses is preset,
wherein the option display part and the option button part are configured to emit light together, and
wherein the option display part and the option button part emit light together based on the option group for a course currently displayed in the screen output part.

18. The laundry treatment apparatus of claim 12, further comprising an additional option part positioned on the other side of the screen output part based on the width direction and manipulated by the user to adjust an additional option other than the option related to the general option part.

19. The laundry treatment apparatus of claim 18, wherein the screen output part and the movement button part are disposed between the general option part and the additional option part based on the width direction.

20. The laundry treatment apparatus of claim 18, wherein the additional option part includes a plurality of additional option button parts through which different additional options are adjusted, and
wherein the plurality of additional option button parts is arranged in a grid form.

21. The laundry treatment apparatus of claim 18, wherein the additional option part includes a plurality of additional option button parts through which different additional options are adjusted, and
wherein each of the plurality of additional option button parts is configured to display a name of a related additional option and to emit light, and the plurality of additional option button parts emit light based on an additional option settable in the course displayed in the screen output part.

22. The laundry treatment apparatus of claim 18, further comprising a power button part and an execution button part provided in the cabinet,
wherein the screen output part, the movement button part, the general option part, and the additional option part are all disposed between the power button part and the execution button part based on the width direction.

23. The laundry treatment apparatus of claim 22, wherein the movement button part, the power button part, and the execution button part are arranged in parallel in the width direction.

24. A laundry treatment apparatus, comprising:
a cabinet;
a drum rotatably provided inside the cabinet and accommodating clothes therein;
a screen output part provided in the cabinet and configured to output a screen on which a plurality of objects selectable by a user is displayed;
a movement button part provided in the cabinet and manipulated by the user to change a selection target object to be scheduled for selection among the plurality of objects; and
a multi-function button part provided in the cabinet and configured to vary a function according to a screen output from the screen output part,
wherein the multi-function button part is provided inside the screen output part, and the movement button part is provided outside the screen output part.
